(19) United States
(12) Patent Application Publication
(10) Pub. No.: US 2019/0122064 A1
(43) Pub. Date: Apr. 25, 2019

(54) IMAGE PROCESSING APPARATUS, INFORMATION PROCESSING APPARATUS, IMAGE PROCESSING METHOD, INFORMATION PROCESSING METHOD, IMAGE PROCESSING PROGRAM, AND INFORMATION PROCESSING PROGRAM

(71) Applicant: SONY CORPORATION, Tokyo (JP)

(72) Inventors: Noriko ISHIKAWA, Tochigi (JP); Masakazu EBIHARA, Tokyo (JP); Kazuhiro SHIMAUCHI, Tokyo (JP)

(73) Assignee: SONY CORPORATION, Tokyo (JP)

(21) Appl. No.: 16/094,692

(22) PCT Filed: Jun. 19, 2017
(86) PCT No.: PCT/JP2017/022464

§ 371 Date: Oct. 18, 2018

(30) Foreign Application Priority Data
Jul. 1, 2016 (JP) 2016-131656

(51) Int. Cl. G06K 9/32; H04N 5/232; G06K 9/00; G06K 9/46

(52) U.S. Cl. CPC G06K 9/3241; H04N 5/23296; H04N 5/23229; G06K 9/46; G06K 9/00523

(57) ABSTRACT

An electronic system that detects an object from image data captured by a camera; divides a region of the image data corresponding to the object into a plurality of sub-areas based on attribute information of the object and an image capture characteristic of the camera; extracts one or more characteristics corresponding to the object from one or more of the plurality of sub-areas; and generates characteristic data corresponding to the object based on the extracted one or more characteristics

### CROSS REFERENCE TO RELATED APPLICATIONS

This application claims the benefit of Japanese Priority Patent Application JP 2016-131656 filed Jul. 1, 2016, the entire contents of which are incorporated herein by reference.

### TECHNICAL FIELD

The present disclosure relates to an image processing apparatus, an information processing apparatus, an image processing method, an information processing method, an image processing program, and an information processing program. In more detail, the present disclosure relates to an image processing apparatus, an information processing apparatus, an image processing method, an information processing method, an image processing program, and an information processing program that detect an object such as a person and a vehicle from an image.

### BACKGROUND ART

Recently, surveillance cameras (security cameras) are provided in stations, buildings, public roads, or other various kinds of places. Images taken by such surveillance cameras are, for example, sent to a server via a network, and stored in storage means such as a database. The server or a search apparatus (information processing apparatus) connected to the network executes various kinds of data processing by using the taken images. Examples of data processing executed by the server or the search apparatus (information processing apparatus) include searching for an object such as a certain person and a certain vehicle and tracking the object.

A surveillance system using such a surveillance camera executes various kinds of detection processing (e.g., detecting movable target, detecting face, detecting person, etc.) in combination in order to detect a certain object from taken-image data. The processing of detecting objects from images taken by cameras and tracking the objects is used to, for example, find out suspicious persons or criminal persons of many cases.

Recently, the number of such surveillance cameras (security cameras) provided in common places are increasing extremely rapidly. It is said that video images recorded in one year is more than one trillion hours in length. This trend tends to be and will be increasing. It is prospected that the time length of recorded images a few years later will reach several times of the time length of recorded images of now. Nevertheless, in emergencies such as incident occurrences, operators reproduce and confirm an enormous amount of recorded video images one by one, e.g., watch and search the video images, in many cases even now. Operator-staff costs are increasing year by year, which is a problem.

There are known various approaches to solve the above-mentioned problem of increasing data processing amount. For example, Patent Literature 1 (Japanese Patent Application Laid-open No. 2013-186546) discloses an image processing apparatus configured to extract characteristics (color, etc.) of clothes of a person, analyze images by using the extracted characteristic amount, and thereby efficiently extract a person who is estimated as the same person from an enormous amount of data of images taken by a plurality of cameras. The work load of operators may be reduced by using such image analysis processing using a characteristic amount.

However, the above-mentioned analysis processing using an image characteristic amount still has many problems. For example, the configuration of Patent Literature 1 described above only searches for a person, and executes an algorithm of obtaining characteristics such as a color of clothes of a person from images.

The algorithm of obtaining a characteristic amount discerns a person area or a face area in an image, estimates a clothes part, and obtains its color information, and the like. According to the algorithm of obtaining a characteristic amount, a characteristic amount of a person is only obtained.

In some cases, it is necessary to track or search for an object not a person, for example, it is necessary to track a vehicle. In such cases, it is therefore not possible to obtain proper vehicle information (e.g., proper color information on vehicle) even by executing the above-mentioned algorithm of obtaining a characteristic amount of a person disclosed in Patent Literature 1, which is a problem.

### CITATION LIST

### Patent Literature

PTL 1: Japanese Patent Application Laid-open No. 2013-186546

### SUMMARY

### Technical Problem

In view of the above-mentioned circumstances, it is desirable to provide an image processing apparatus, an information processing apparatus, an image processing method, an information processing method, an image processing program, and an information processing program that analyze images properly on the basis of various kinds of objects to be searched for and tracked, and that efficiently execute search processing and track processing on the basis of the kinds of objects with a high degree of accuracy.

According to an embodiment of the present disclosure, for example, an object is divided differently on the basis of an attribute (e.g., a person or a vehicle-type, etc.) of an object to be searched for and tracked, a characteristic amount such as color information is extracted for each divided area on the basis of the kind of an object, and the characteristic amount is analyzed. There are provided an image processing apparatus, an information processing apparatus, an image processing method, an information processing method, an image processing program, and an information processing program capable of efficiently searching for and tracking an object on the basis of the kind of the object with a high degree of accuracy by means of the abovementioned processing.

### Solution to Problem

According to a first embodiment, the present disclosure is directed to an electronic system including circuitry configured to: detect an object from image data captured by a camera; divide a region of the image data corresponding to the object into a plurality of sub-areas based on attribute information of the object and an image capture characteristic of the camera; extract one or more characteristics corresponding to the object from one or more of the plurality of sub-areas; and

generate characteristic data corresponding to the object based on the extracted one or more characteristics.

The attribute information indicates a type of the detected object, and the circuitry determines a number of the plurality of sub-areas into which to divide the region based on the type of the object.

The attribute information may indicate an orientation of the detected object, and the circuitry determines a number of the plurality of sub-areas into which to divide the region based on the orientation of the object.

The image capture characteristic of the camera may include an image capture angle of the camera, and the circuitry determines a number of the plurality of sub-areas into which to divide the region based on the image capture angle of the camera.

The circuitry may be configured to determine a number of the plurality of sub-areas into which to divide the region based on a size of the region of the image data corresponding to the object.

The circuitry may be configured to determine the one or more of the plurality of sub-areas from which to extract the one or more characteristics corresponding to the object.

According to another exemplary embodiment, the disclosure is directed to a method performed by an electronic system, the method including: detecting an object from image data captured by a camera; dividing a region of the image data corresponding to the object into a plurality of sub-areas based on attribute information of the object and an image capture characteristic of the camera; extracting one or more characteristics corresponding to the object from one or more of the plurality of sub-areas; and generating characteristic data corresponding to the object based on the extracted one or more characteristics.

According to another exemplary embodiment, the disclosure is directed to a non-transitory computer-readable medium including computer-program instructions, which when executed by an electronic system, cause the electronic system to: detect an object from image data captured by a camera; divide a region of the image data corresponding to the object into a plurality of sub-areas based on attribute information of the object and an image capture characteristic of the camera; extract one or more characteristics corresponding to the object from one or more of the plurality of sub-areas; and generate characteristic data corresponding to the object based on the extracted one or more characteristics.

According to another exemplary embodiment, the disclosure is directed to an electronic device including a camera configured to capture image data; circuitry configured to: detect a target object from the image data; set a frame on a target area of the image data based on the detected target object; determine an attribute of the target object in the frame; divide the frame into a plurality of sub-areas based on an attribute of the target object and an image capture parameter of the camera; determine one or more of the sub-areas from which a characteristic of the target object is to be extracted based on the attribute of the target object, the image capture parameter and a size of the frame; extract the characteristic from the one or more of the sub-areas; and generate metadata corresponding to the target object based on the extracted characteristic; and a communication interface configured to transmit the image data and the metadata to a device remote from the electronic device via a network

### BRIEF DESCRIPTION OF DRAWINGS

FIG. 1 is a diagram showing an example of an information processing system to which the processing of the present disclosure is applicable.

FIG. 2 is a flowchart illustrating a processing sequence of searching for and tracking an object.

FIG. 3 is a diagram illustrating an example of data (UI: user interface) displayed on the search apparatus at the time of searching for and tracking an object.

FIG. 4 is a diagram illustrating an example of data (UI: user interface) displayed on the search apparatus at the time of searching for and tracking an object.

FIG. 5 is a diagram illustrating an example of data (UI: user interface) displayed on the search apparatus at the time of searching for and tracking an object.

FIG. 6 is a diagram illustrating an example of data (UI: user interface) displayed on the search apparatus at the time of searching for and tracking an object.

FIG. 7 is a flowchart illustrating an example of processing of calculating priority of a candidate object.

FIG. 8 is a diagram illustrating an example of configuration and communication data of the apparatuses of the information processing system.

FIG. 9 is a diagram illustrating configuration and processing of the metadata generating unit of the camera (image processing apparatus) in detail.

FIG. 10 is a diagram illustrating configuration and processing of the metadata generating unit of the camera (image processing apparatus) in detail.

FIG. 11 is a diagram illustrating configuration and processing of the metadata generating unit of the camera (image processing apparatus) in detail.

FIG. 12 is a diagram illustrating a specific example of the attribute-corresponding movable-target-frame-dividing-information register table, which is used to generate metadata by the camera (image processing apparatus).

FIG. 13 is a diagram illustrating a specific example of the attribute-corresponding movable-target-frame-dividing-information register table, which is used to generate metadata by the camera (image processing apparatus).

FIG. 14 is a diagram illustrating a specific example of the attribute-corresponding movable-target-frame-dividing-information register table, which is used to generate metadata by the camera (image processing apparatus).

FIG. 15 is a diagram illustrating a specific example of the characteristic-amount-extracting-divided-area information register table, which is used to generate metadata by the camera (image processing apparatus).

FIG. 16 is a diagram illustrating a specific example of the characteristic-amount-extracting-divided-area information register table, which is used to generate metadata by the camera (image processing apparatus).

FIG. 17 is a diagram illustrating a specific example of the characteristic-amount-extracting-divided-area information register table, which is used to generate metadata by the camera (image processing apparatus).

FIG. 18 is a diagram illustrating specific examples of modes of setting divided areas differently on the basis of different camera-depression angles, and modes of setting characteristic-amount-extracting-areas.

FIG. 19 is a flowchart illustrating in detail a sequence of generating metadata by the camera (image processing apparatus).

FIG. 20 is a diagram illustrating an example of data (UI: user interface) displayed on the search apparatus at the time of searching for an object.

FIG. 21 is a diagram illustrating an example of data (UI: user interface) displayed on the search apparatus at the time of searching for an object.

FIG. 22 is a diagram illustrating an example of data (UI: user interface) displayed on the search apparatus at the time of searching for an object.

FIG. 23 is a diagram illustrating an example of data (UI: user interface) displayed on the search apparatus at the time of searching for an object.

FIG. 24 is a diagram illustrating an example of data (UI: user interface) displayed on the search apparatus at the time of searching for an object.

FIG. 25 is a diagram illustrating a processing example, in which the search apparatus, which searches for an object, specifies a new movable-target frame and executes processing requests.

FIG. 26 is a diagram illustrating an example of data (UI: user interface) displayed on the search apparatus at the time of searching for an object.

FIG. 27 is a diagram illustrating an example of the hardware configuration of the camera (image processing apparatus).

FIG. 28 is a diagram illustrating an example of the hardware configuration of each of the storage apparatus (server) and the search apparatus (information processing apparatus).

### DESCRIPTION OF EMBODIMENTS

Hereinafter, an image processing apparatus, an information processing apparatus, an image processing method, an information processing method, an image processing program, and an information processing program of the present disclosure will be described in detail with reference to the drawings. Note that description will be made in the order of the following items.

1. Configurational example of an information processing system to which the processing of the present disclosure is applicable

2. Example of a sequence of the processing of searching for and tracking a certain object

3. Example of how to extract candidate objects on the basis of characteristic information, and example of how to set priority

4. Configuration and processing of setting characteristic-amount-extracting-area corresponding to object attribute

5. Sequence of generating metadata by metadata generating unit of camera (image processing apparatus)

6. Processing of searching for and tracking object by search apparatus (information processing apparatus)

7. Examples of hardware configuration of each of cameras and other apparatuses of information processing system

8. Conclusion of configuration of present disclosure

### 1. Configurational Example of an Information Processing System to Which the Processing of the Present Disclosure is Applicable

Firstly, a configurational example of an information processing system to which the processing of the present disclosure is applicable will be described.

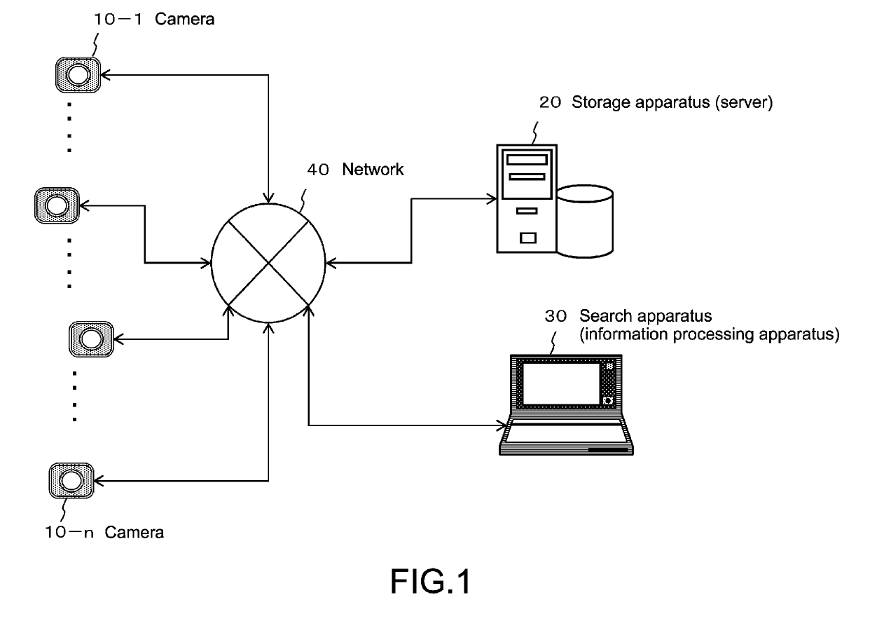

FIG. 1 is a diagram showing a configurational example of an information processing system to which the processing of the present disclosure is applicable.

The information processing system of FIG. 1 includes the one or more cameras (image processing apparatuses) 10-1 to 10-n, the storage apparatus (server) 20, and the search apparatus (information processing apparatus) 30 connected to each other via the network 40.

Each of the cameras (image processing apparatuses) 10-1 to 10-n takes, records, and analyzes a video image, generates information (metadata) obtained as a result of analyzing the video image, and outputs the video image data and the information (metadata) via the network 40.

The storage apparatus (server) 20 receives the taken image (video image) and the metadata corresponding to the image from each camera 10 via the network 40, and stores the image (video image) and the metadata in a storage unit (database). In addition, the storage apparatus (server) 20 inputs a user instruction such as a search request from the search apparatus (information processing apparatus) 30, and processes data.

The storage apparatus (server) 20 processes data by using the taken images and the metadata received from the cameras 10-1 to 10-n, for example, in response to the user instruction input from the search apparatus (information processing apparatus) 30. For example, the storage apparatus (server) 20 searches for and tracks a certain object, e.g., a certain person, in an image.

The search apparatus (information processing apparatus) 30 receives input instruction information on an instruction from a user, e.g., a request to search for a certain person, and sends the input instruction information to the storage apparatus (server) 20 via the network 40. Further, the search apparatus (information processing apparatus) 30 receives an image as a search result or a tracking result, search and tracking result information, and other information from the storage apparatus (server) 20, and outputs such information on a display.

Note that FIG. 1 shows an example in which the storage apparatus 20 and the search apparatus 30 are configured separately. Alternatively, a single information processing apparatus may be configured to have the functions of the search apparatus 30 and the storage apparatus 20. Further, FIG. 1 shows the single storage apparatus 20 and the single search apparatus 30. Alternatively, a plurality of storage apparatuses 20 and a plurality of search apparatuses 30 may be connected to the network 40, and the respective servers and the respective search apparatuses may execute various information processing and send/receive the processing results to/from each other. Configurations other than the above may also be employed.

### 2. Example of a Sequence of the Processing of Searching for and Tracking a Certain Object

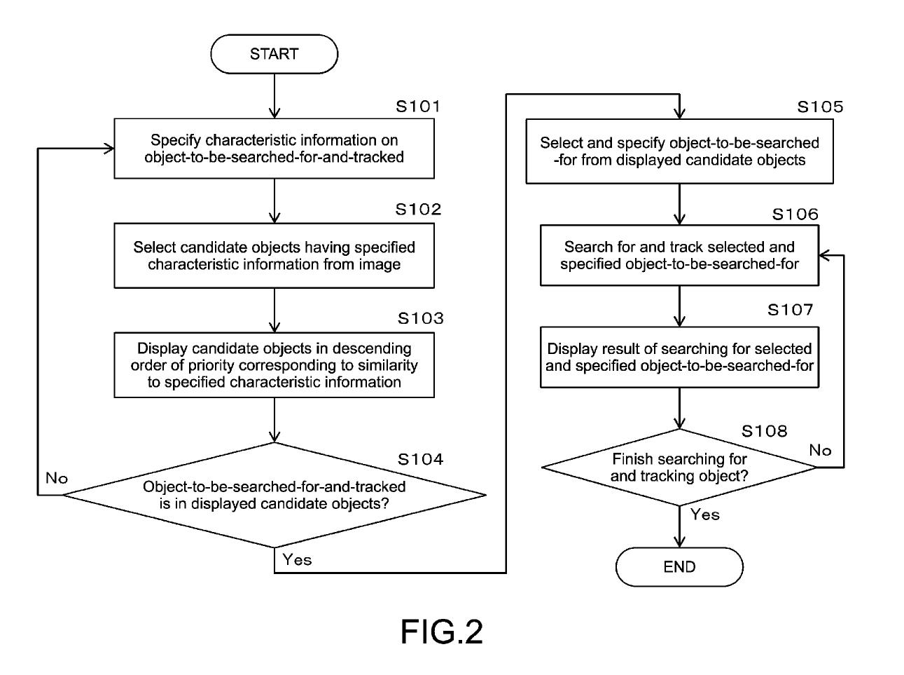

Next, an example of a sequence of the processing of searching for and tracking a certain object by using the information processing system of FIG. 1 will be described with reference to the flowchart of FIG. 2.

The flow of FIG. 2 shows a general processing flow of searching for and tracking a certain object where an object-to-be-searched-for-and-tracked is specified by a user who uses the search apparatus 30 of FIG. 1.

The processes of the steps of the flowchart of FIG. 2 will be described in order.

(Step S101)

Firstly, in Step S101, a user who uses the search apparatus (information processing apparatus) 30 inputs characteristic information on an object-to-be-searched-for-and-tracked in the search apparatus 30.

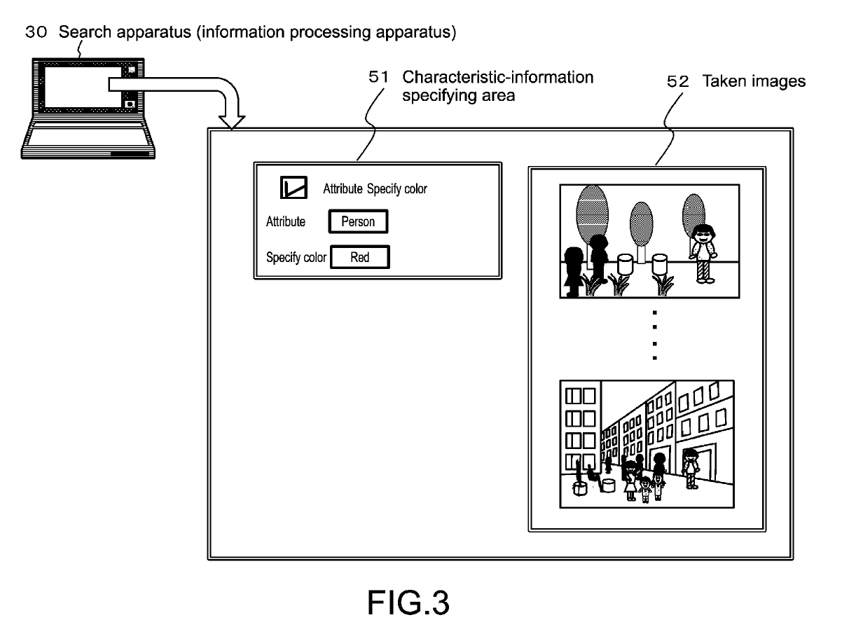

FIG. 3 shows an example of data (user interface) displayed on a display unit (display) on the search apparatus 30 at the time of this processing.

The user interface of FIG. 3 is an example of a user interface displayed on the display unit (display) of the search apparatus 30 when the search processing is started.

The characteristic-information specifying area 51 is an area in which characteristic information on an object-to-be-searched-for-and-tracked is input.

A user who operates the search apparatus 30 can input characteristic information on an object-to-be-searched-for-and-tracked in the characteristic-information specifying area 51.

The example of FIG. 3 shows an example of specifying the attribute and the color as the characteristic information on an object-to-be-searched-for-and-tracked.

Attribute=person,

Color=red

Such specifying information is input.

This specifying information means to search for a person with red clothes, for example.

The taken images 52 are images being taken by the cameras 10-1 to 10-n connected via the network, or images taken before by the cameras 10-1 to 10-n and stored in the storage unit of the storage apparatus (server) 20.

In Step S101, characteristic information on an object-to-be-searched-for-and-tracked is input in the search apparatus 30 by using the user interface of FIG. 3, for example.

(Step S102)

Next, in Step S102, the search apparatus 30 searches the images taken by the cameras for candidate objects, the characteristic information on the candidate objects being the same as or similar to the characteristic information on the object-to-be-searched-for specified in Step S101.

Note that the search apparatus 30 may be configured to search for candidate objects. Alternatively, the search apparatus 30 may be configured to send a search command to the storage apparatus (server) 20, and the storage apparatus (server) 20 may be configured to search for candidate objects.

(Steps S103 to S105)

Next, in Step S103, the search apparatus 30 displays, as the search result of Step S102, a listing of candidate objects, the characteristic information on the candidate objects being the same as or similar to the characteristic information specified by a user in Step S101, as a candidate-object list on the display unit.

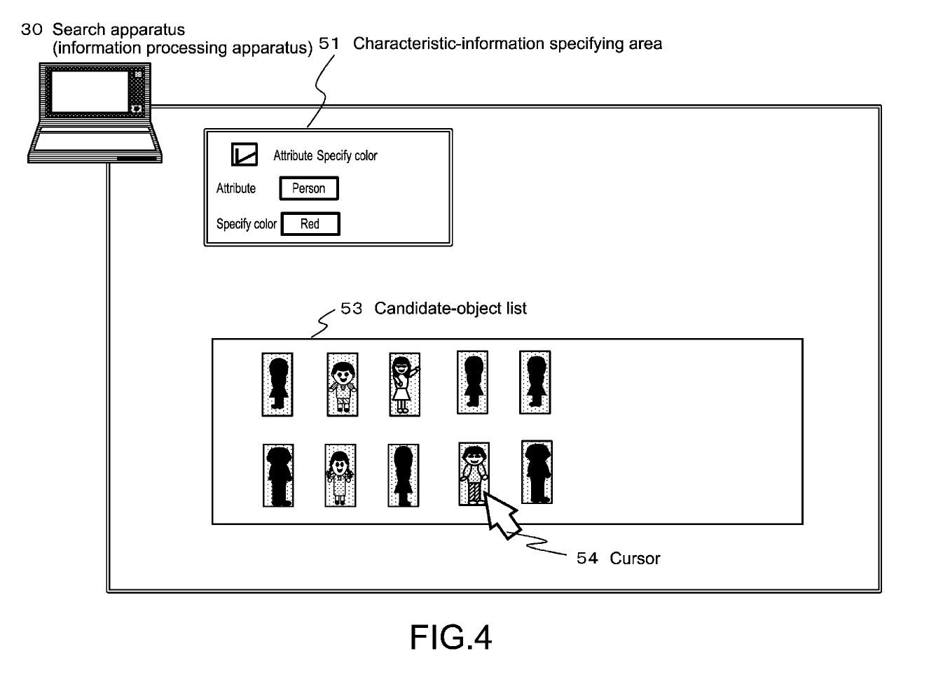

FIG. 4 shows an example of the display data.

The user interface of FIG. 4 displays the characteristic-information specifying area 51 described with reference to FIG. 3, and, in addition, the candidate-object list 53.

The candidate-object list 53 displays a plurality of objects, the characteristic information on which is the same as or similar to the information (e.g., attribute=person, color=red) specified as the characteristic information on the object-to-be-searched-for by a user, for example, in descending order of similarity (descending order of priority) and in the order of image-taking time.

Note that, in real-time search processing in which images being currently taken by cameras are used, listed image are updated with newly-taken images in sequence, i.e., such display update processing is executed successively. Further, in search processing in which images taken before, i.e., images already stored in the storage unit of the storage apparatus (server) 20, are used, images on a static list are displayed without updating the listed images.

A user of the search apparatus 30 finds out an object-to-be-searched-for from the candidate-object list 53 displayed on the display unit, and then selects the object-to-be-searched-for by specifying it with the cursor 54 as shown in FIG. 4, for example.

This processing corresponds to the processing in which it is determined Yes in Step S104 of FIG. 2 and the processing of Step S105 is executed.

Where a user cannot find out an object-to-be-searched-for in the candidate-object list 53 displayed on the display unit, the processing returns to Step S101. The characteristic information on the object-to-be-searched-for is changed and the like, and the processing on and after Step S101 is repeated.

This processing corresponds to the processing in which it is determined No in Step S104 of FIG. 2 and the processing returns to of Step S101.

(Steps S106 to S107)

In Step S105, the object-to-be-searched-for is specified from the candidate objects. Then, in Step S106, the processing of searching for and tracking the selected and specified object-to-be-searched-for in the images is started.

Further, in Step S107, the search-and-tracking result is displayed on the display unit of the search apparatus 30.

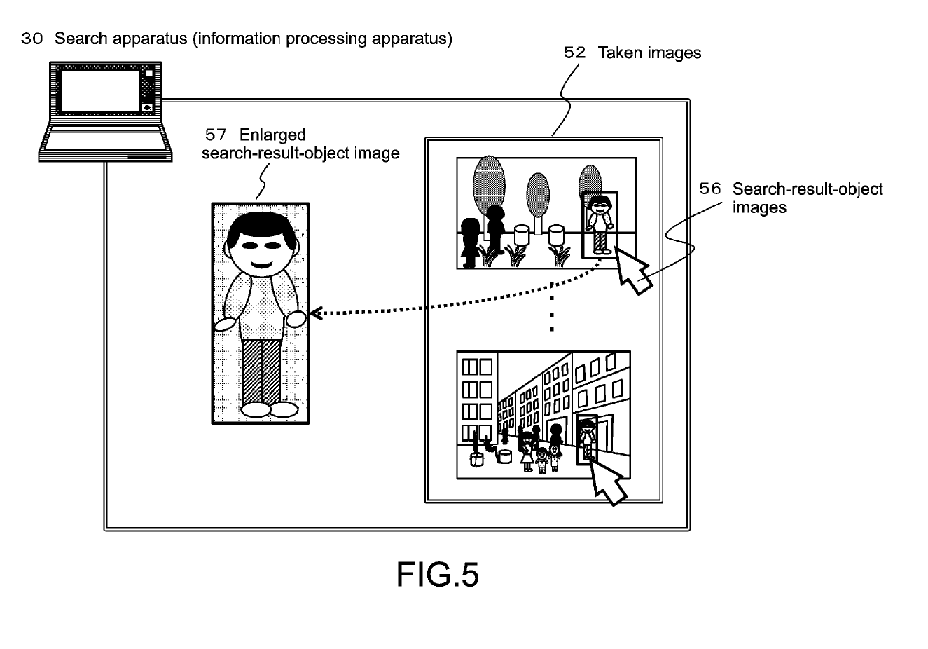

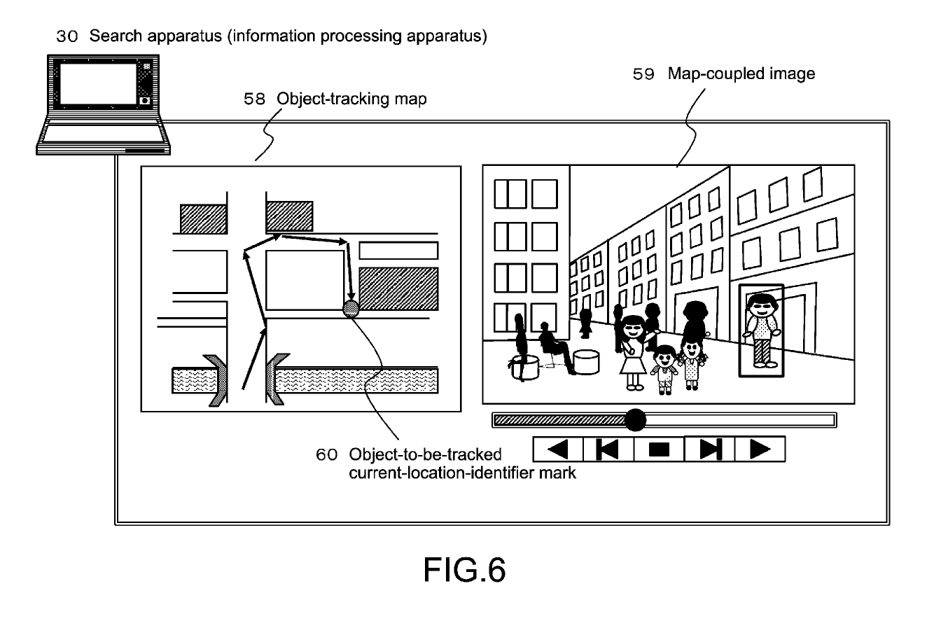

Various display examples are available for an image displayed when executing the processing, i.e., a display mode for display the search result. With reference to FIG. 5 and FIG. 6, display examples are to be described.

According to a search-result-display example of FIG. 5, the search-result-object images 56, which are obtained by searching the images 52 taken by the respective cameras, and the enlarged search-result-object image 57 are displayed as search results.

Further, according to a search-result-display example of FIG. 6, the object-tracking map 58 and the map-coupled image 59 are displayed side by side. The object-tracking map 58 is a map including arrows, which indicate the moving route of the object-to-be-searched-for, on the basis of location information on the camera provided at various locations.

The object-to-be-tracked current-location-identifier mark 60 is displayed on the map.

The map-coupled image 59 displays the image being taken by the camera, which is taking an image of the object indicated by the object-to-be-tracked current-location-identifier mark 60.

Note that each of the display-data examples of FIG. 5 and FIG. 6 is an example of search-result display data. Alternatively, any of various other display modes are available.

(Step S108)

Finally, it is determined if searching for and tracking the object is to be finished or not. It is determined on the basis of an input by a user.

Where an input by a user indicates finishing the processing, it is determined Yes in Step S108 and the processing is finished.

Where an input by a user fails to indicate finishing the processing, it is determined No in Step S108 and the processing of searching for and tracking the object-to-be-searched-for is continued in Step S106.

An example of a sequence of the processing of searching for an object, to which the network-connected information processing system of FIG. 1 is applied, has been described.

Note that the processing sequences and the user interfaces described with reference to FIG. 5 and FIG. 6 are examples of the object-search processing generally and widely executed. Alternatively, other processing on the basis of various different sequences and other processing using user interfaces including different display data are available.

### 3. Example of How to Extract Candidate Objects on the Basis of Characteristic Information, and Example of How to Set Priority

In Steps S102 and S103 of the flow described with reference to FIG. 2, the search apparatus 30 extracts candidate objects from the images on the basis of characteristic information (e.g., characteristic information such as attribute=person, color=red, etc.) of an object specified by a user, sets priority to the extracted candidate objects, generates a list in the order of priority, and displays the list. In short, the search apparatus 30 generates and displays the candidate-object list 53 of FIG. 4.

Desirably, in the candidate-object list 53 of FIG. 4, the candidate objects are displayed in descending order, in which the candidate object determined closest to the object to be searched for by a user has the first priority. Desirably, to realize this processing, the priority of each of the candidate objects is calculated, and the candidate objects are displayed in descending order of the calculated priority.

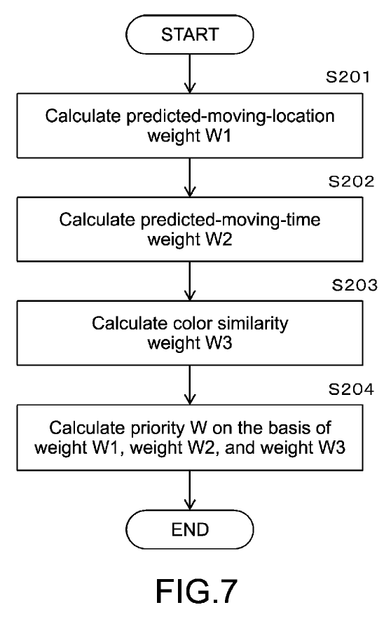

With reference to the flowchart of FIG. 7, an example of the sequence of calculating priority will be described.

Note that there are various methods, i.e., modes, of calculating priority. Different kinds of priority-calculation processing are executed on the basis of circumstances.

In the example of the flow of FIG. 7, the object-to-be-searched-for is a criminal person of an incident, for example. The flow of FIG. 7 shows an example of calculating priority where information on the incident-occurred location, information on the incident-occurred time, and information on the clothes (color of clothes) of the criminal person at the time of occurrence of the incident are obtained.

A plurality of candidate objects are extracted from many person images in the images taken by the cameras. A higher priority is set for a candidate object, which has a higher probability of being a criminal person, out of the plurality of candidate objects.

Specifically, priority is calculated for each of the candidate objects detected from the images on the basis of three kinds of data, i.e., location, time, and color of clothes, as the parameters for calculating priority.

Note that the flow of FIG. 7 is executed on the condition that a plurality of candidate objects, which have characteristic information similar to the characteristic information specified by a user, are extracted and that data corresponding to the extracted candidate objects, i.e., image-taking location, image-taking time, and color of clothes, are obtained.

Hereinafter, with reference to the flowchart of FIG. 7, the processing of each step will be described in order.

(Step S201)

Firstly, in Step S201, the predicted-moving-location weight W1 corresponding to each candidate object is calculated, where image-taking location information on the candidate object extracted from the images is applied.

The predicted-moving-location weight W1 is calculated as follows, for example.

A predicted moving direction of a search-object to be searched for (criminal person) is determined on the basis of the images of the criminal person taken at the time of occurrence of the incident. For example, the moving direction is estimated on the basis of the images of the criminal person running away and other images. Where the image-taking location of each taken image including a candidate object more matches the estimated moving direction, the predicted-moving-location weight W1 is set higher.

Specifically, for example, the distance D is multiplied by the angle θ, and the calculated value D*θ is used as the predicted-moving-location weight W1. The distance D is between the location of the criminal person defined on the basis of the images taken at the time of occurrence of the incident, and the location of the candidate object defined on the basis of the taken image including the candidate object. Alternatively, a predefined function f1 is applied, and the predicted-moving-location weight W1 is calculated on the basis of the formula W1=f1(D*0).

(Step S202)

Next, in Step S202, the image-taking time information on each candidate object extracted from each image is applied, and the predicted-moving-time weight W2 corresponding to each candidate object is calculated.

The predicted-moving-time weight W2 is calculated as follows, for example.

Where the image-taking time of each taken image including a candidate object more matches the time determined as the time difference corresponding to the moving distance calculated on the basis of each image, the predicted-moving-time weight W2 is set higher. The time difference is determined on the basis of the elapsed time after the image-taking time, at which the image of the search-object to be searched for (criminal person) is taken at the time of occurrence of the incident.

Specifically, for example, D/V is calculated and used as the predicted-moving-time weight W2. The motion vector V of the criminal person is calculated on the basis of the moving direction and speed of the criminal person, which are defined on the basis of the images taken at the time of occurrence of the incident. The distance D is between the location of the criminal person defined on the basis of the images taken at the time of occurrence of the incident, and the location of a candidate object defined on the basis of a taken image including a candidate object. Alternatively, a predefined function f2 is applied, and the predicted-moving-time weight W2 is calculated on the basis of the formula W2=f2(D/V).

(Step S203)

Next, in Step S203, information on clothes, i.e., color of clothes, of each candidate object extracted from each image is applied, and the color similarity weight W3 corresponding to each candidate object is calculated.

The color similarity weight W3 is calculated as follows, for example.

Where it is determined that the color of clothes of the candidate object is more similar to the color of clothes of the criminal person defined on the basis of each image of the search-object to be searched for (criminal person) taken at the time of occurrence of the incident, the color similarity weight W3 is set higher.

Specifically, for example, the similarity weight is calculated on the basis of H (hue), S (saturation), V (luminance), and the like. Ih, Is, and Iv denote H (hue), S (saturation), and V (luminance) of the color of clothes defined on the basis of each image of the criminal person taken at the time of occurrence of the incident.

Further, Th, Ts, and Tv denote H (hue), S (saturation), and V (luminance) of the color of clothes of the candidate object. Those values are applied, and the color similarity weight W3 is calculated on the basis of the following formula.

W3=(Ih−Th)²+(Is−Ts)²+(Iv−Tv)²)

The color similarity weight W3 is calculated on the basis of the above formula.

Alternatively, a predefined function f3 is applied.

W3=f3((Ih−Th)²+(Is−Ts)²+(Iv−Tv)²)

The color similarity weight W3 is calculated on the basis of the above formula.

(Step S204)

Finally, in Step S204, on the basis of the following three kinds of weight information calculated in Steps S201 to S203, i.e.,

the predicted-moving-location weight W1,

the predicted-moving-time weight W2, and

the color similarity weight W3,

i.e., on the basis of the respective kinds of weight, the integrated priority W is calculated on the basis of the following formula.

W=W1*W2*W3

Note that a predefined coefficient may be set for each weight, and the integrated priority W may be calculated as follows.

### W=αW1*βW2*γW3

Priority is calculated for each candidate object as described above. Where the calculated priority is higher, the displayed location is closer to the top position of the candidate-object list 53 of FIG. 4.

Since the candidate objects are displayed in the order of priority, a user can find out the object-to-be-searched-for-and-tracked from the list very quickly.

Note that, as described above, there are various methods, i.e., modes, of calculating priority. Different kinds of priority-calculation processing are executed on the basis of circumstances.

Note that the object-search processing described with reference to FIG. 2 to FIG. 7 is an example of the search processing on the basis of a characteristic amount of an object generally executed.

The information processing system similar to that of FIG. 1 is applied to the object-search processing of the present disclosure. A different characteristic amount is extracted on the basis of an object attribute, i.e., an object attribute indicating if an object-to-be-searched-for is a person, a vehicle, or the like, for example.

According to the processing specific to the present disclosure, it is possible to search for and track an object more reliably and efficiently.

In the following item, the processing of the present disclosure will be described in detail.

In other words, the configuration and processing of the apparatus, which extracts a different characteristic amount on the basis of an object attribute, and searches for and tracks an object on the basis of the extracted characteristic amount corresponding to the object attribute, will be described in detail.

### 4. Configuration and Processing of Setting Characteristic-Amount-Extracting-Area Corresponding to Object Attribute

Hereinafter, the object-searching configuration and processing of the present disclosure, which sets a characteristic-amount-extracting-area corresponding to an object attribute, will be described.

In the following description, the information processing system of the present disclosure is similar to the system described with reference to FIG. 1. In other words, as shown in FIG. 1, the information processing system includes the cameras (image processing apparatuses) 10, the storage apparatus (server) 20, and the search apparatus (information processing apparatus) 30 connected to each other via the network 40.

Note that this information processing system includes an original configuration for setting a characteristic-amount-extracting-area on the basis of an object attribute.

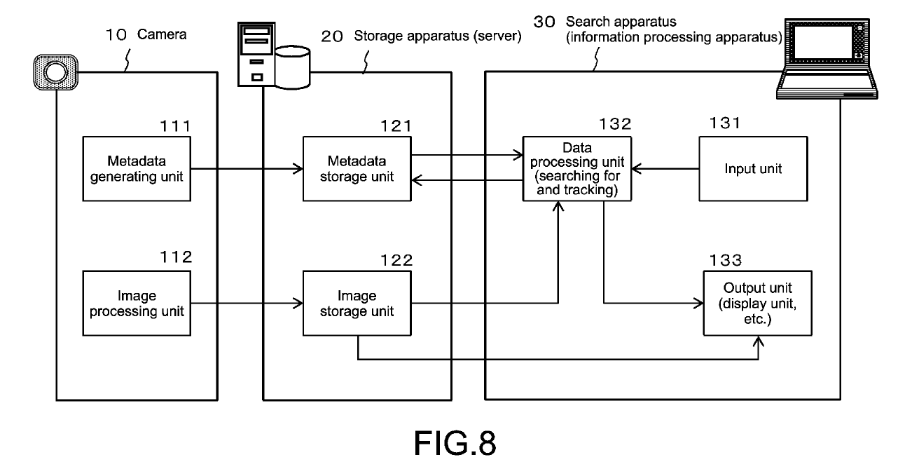

FIG. 8 is a diagram illustrating the configuration and processing of the camera (image processing apparatus) 10, the storage apparatus (server) 20, and the search apparatus (information processing apparatus) 30.

The camera 10 includes the metadata generating unit 111 and the image processing unit 112.

The metadata generating unit 111 generates metadata corresponding to each image frame taken by the camera 10.
Specific examples of metadata will be described later. For example, metadata, which includes characteristic amount information corresponding to an object attribute (a person, a vehicle, or the like) of an object of a taken image and includes other information, is generated.

The metadata generating unit 111 of the camera 10 extracts a different characteristic amount on the basis of an object attribute, i.e., an object attribute detected from a taken image (e.g., if an object is a person, a vehicle, or the like). According to the original processing of the present disclosure, it is possible to search for and track an object more reliably and efficiently.

The metadata generating unit 111 of the camera 10 detects a movable-target object from an image taken by the camera 10, determines an attribute (a person, a vehicle, or the like) of the detected movable-target object, and further decides a dividing mode of dividing a movable target area (object) on the basis of the determined attribute. Further, the metadata generating unit 111 decides a divided area whose characteristic amount is to be extracted, and extracts a characteristic amount (e.g., color information, etc.) of the movable target from the decided divided area.

Note that the configuration and processing of the metadata generating unit 111 will be described in detail later.

The image processing unit 112 processes images taken by the camera 10. Specifically, for example, the image processing unit 112 receives input image data (RAW image) output from the image-taking unit (image sensor) of the camera 10, reduces noises in the input RAW image, and executes other processing. Further, the image processing unit 112 executes signal processing generally executed by a camera. For example, the image processing unit 112 demosaics the RAW image, adjusts the white balance (WB), executes gamma correction, and the like. In the demosaic processing, the image processing unit 112 sets pixel values corresponding to the full RGB colors to the pixel positions of the RAW image. Further, the image processing unit 112 encodes and compresses the image and executes other processing to send the image.

The images taken by the camera 10 and the metadata generated corresponding to the respective taken images are sent to the storage apparatus (server) 20 via the network.

The storage apparatus (server) 20 includes the metadata storage unit 121 and the image storage unit 122.

The metadata storage unit 121 is a storage unit that stores the metadata corresponding to the respective images generated by the metadata generating unit 111 of the camera 10.

The image storage unit 122 is a storage unit that stores the image data taken by the camera 10 and generated by the image processing unit 112.

Note that the metadata storage unit 121 records the above-mentioned metadata generated by the metadata generating unit 111 of the camera 10 (i.e., the characteristic amount obtained from a characteristic-amount-extracting-area decided on the basis of an attribute (a person, a vehicle, or the like) of an object, e.g., a characteristic amount such as color information, etc.) in relation with area information from which the characteristic amount is extracted.

A configurational example of stored data of a specific characteristic amount, which is stored in the metadata storage unit 121, will be described later.

The search apparatus (information processing apparatus) 30 includes the input unit 131, the data processing unit 132, and the output unit 133.

The input unit 131 includes, for example, a keyboard, a mouse, a touch-panel-type input unit, and the like. The input unit 131 is used to input various kinds of processing requests from a user, for example, an object search request, an object track request, an image display request, and the like.

The data processing unit 132 processes data in response to processing requests input from the input unit 131. Specifically, the data processing unit 132 searches for and tracks an object, for example, by using the above-mentioned metadata stored in the metadata storage unit 121 (i.e., the characteristic amount obtained from a characteristic-amount-extracting-area decided on the basis of an attribute (a person, a vehicle, or the like) of an object, e.g., a characteristic amount such as color information, etc.) and by using the characteristic-amount-extracting-area information.

The output unit 133 includes a display unit (display), a speaker, and the like. The output unit 133 outputs data such as the images taken by the camera 10 and search-and-tracking results.

Further, the output unit 133 is also used to output user interfaces, and also functions as the input unit 131.

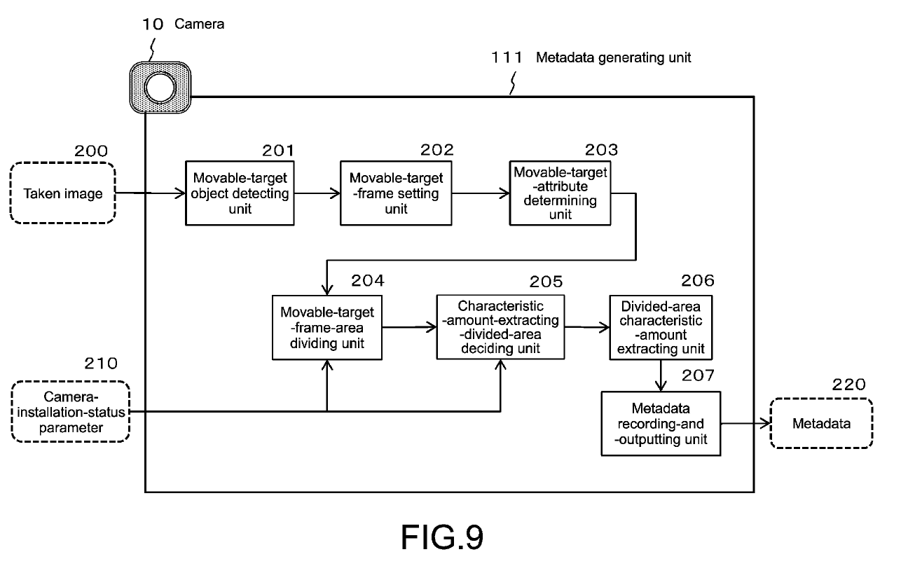

Next, with reference to FIG. 9, the configuration and processing of the metadata generating unit 111 of the camera (image processing apparatus) 10 will be described in detail.

As described above, the metadata generating unit 111 of the camera 10 detects a movable-target object from an image taken by the camera 10, determines an attribute (a person, a vehicle, or the like) of the detected movable-target object, and further decides a dividing mode of dividing a movable target area (object) on the basis of the determined attribute. Further, the metadata generating unit 111 decides a divided area whose characteristic amount is to be extracted, and extracts a characteristic amount (e.g., color information, etc.) of the movable target from the decided divided area.

As shown in FIG. 9, the metadata generating unit 111 includes the movable-target object detecting unit 201, the movable-target-frame setting unit 202, the movable-target-attribute determining unit 203, the movable-target-frame-area dividing unit 204, the characteristic-amount-extracting-divided-area deciding unit 205, the divided-area characteristic-amount extracting unit 206, and the metadata recording-and-outputting unit 207.

The movable-target object detecting unit 201 receives the taken image 200 input from the camera 10. Note that the taken image 200 is, for example, a motion image. The movable-target object detecting unit 201 receives the input image frames of the motion image taken by the camera 10 in series.

The movable-target object detecting unit 201 detects a movable-target object from the taken image 200. The movable-target object detecting unit 201 detects the movable-target object by applying a known method of detecting a movable target, e.g., processing of detecting a movable target on the basis of differences of pixel values of serially-taken images, etc.

The movable-target-frame setting unit 202 sets a frame on the movable target area detected by the movable-target object detecting unit 201. For example, the movable-target-frame setting unit 202 sets a rectangular frame surrounding the movable target area.

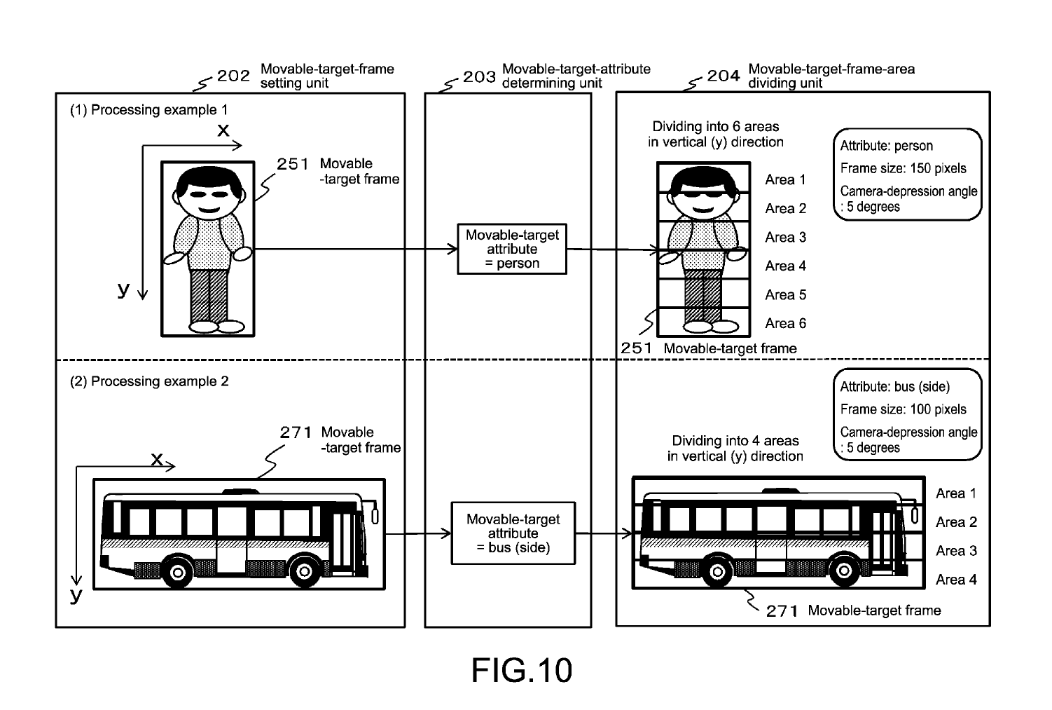

FIG. 10 shows a specific example of setting a movable-target frame by the movable-target-frame setting unit 202.

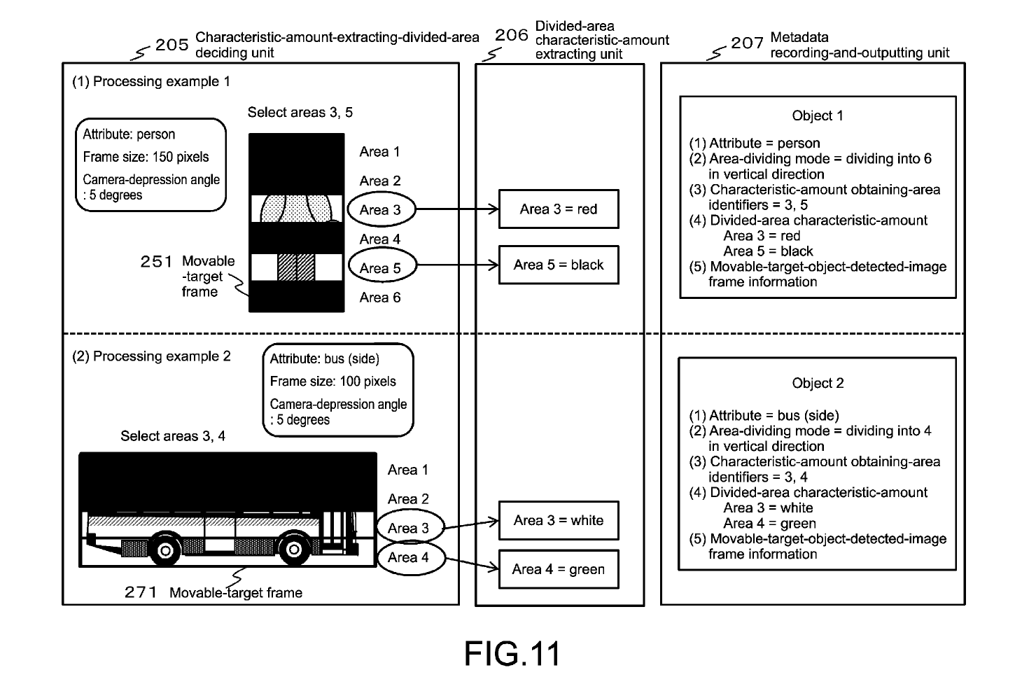

FIG. 10 and FIG. 11 show specific examples of the processing executed by the movable-target-frame setting unit 202 to the metadata recording-and-outputting unit 207 of the metadata generating unit 111 of FIG. 9.

Note that each of FIG. 10 and FIG. 11 shows the following two processing examples in parallel as specific examples, i.e.,

(1) processing example 1=processing example where a movable target is a person, and

(2) processing example 2=processing example where a movable target is a bus.

In FIG. 10, the processing example 1 of the movable-target-frame setting unit 202 shows an example of how to set a movable-target frame 251 where a movable target is a person.

The movable-target frame 251 is set as a frame surrounding the entire person-image area, which is the movable target area.

Further, in FIG. 10, the processing example 2 of the movable-target-frame setting unit 202 shows an example of how to set a movable-target frame 271 where a movable target is a bus.

The movable-target frame 271 is set as a frame surrounding the entire bus-image area, which is the movable target area.

Next, the movable-target-attribute determining unit 203 determines the attribute (specifically, a person or a vehicle, in addition, the kind of vehicle, e.g., a passenger vehicle, a bus, a truck, etc.) of the movable target in the movable-target frame set by the movable-target-frame setting unit 202.

Further, where the attribute of the movable target is a vehicle, the movable-target-attribute determining unit 203 determines whether the vehicle faces front or side.

The movable-target-attribute determining unit 203 determines such an attribute by checking the movable target against, for example, library data preregistered in the storage unit (database) of the camera 10. The library data records characteristic information on shapes of various movable targets such as persons, passenger vehicles, and buses.

Note that the movable-target-attribute determining unit 203 is capable of determining various kinds of attributes on the basis of library data that the movable-target-attribute determining unit 203 uses, in addition to the attributes such as a person or a vehicle-type of a vehicle.

For example, the library data registered in the storage unit may be characteristic information on movable targets such as trains and animals, e.g., dogs, cats, and the like. In such a case, the movable-target-attribute determining unit 203 is also capable of determining the attributes of such movable targets by checking the movable targets against the library data.

In FIG. 10, the processing example 1 of the movable-target-attribute determining unit 203 is an example of the movable-target attribute determination processing where the movable target is a person.

The movable-target-attribute determining unit 203 checks the shape of the movable target in the movable-target frame 251 against library data, in which characteristic information on various movable targets is registered, and determines that the movable target in the movable-target frame 251 is a person. The movable-target-attribute determining unit 203 records the movable-target attribute information, i.e., movable-target attribute=person, in the storage unit of the camera 10 on the basis of the result of determining.

Meanwhile, in FIG. 10, the processing example 2 of the movable-target-attribute determining unit 203 is an example of the movable-target attribute determination processing where the movable target is a bus.

The movable-target-attribute determining unit 203 checks the shape of the movable target in the movable-target frame 271 against library data, in which characteristic information on various movable targets is registered, and determines that the movable target in the movable-target frame 271 is a bus seen from the side. The movable-target-attribute determining unit 203 records the movable-target attribute information, i.e., movable-target attribute=bus (side), in the storage unit of the camera 10 on the basis of the result of determining.

Next, the movable-target-frame-area dividing unit 204 divides the movable-target frame set by the movable-target-frame setting unit 202 on the basis of the attribute of the movable-target determined by the movable-target-attribute determining unit 203.

Note that the movable-target-frame-area dividing unit 204 divides the movable-target frame with reference to the size of the movable-target frame set by the movable-target-frame setting unit 202 and to the camera-installation-status parameter 210 (specifically, a depression angle, i.e., an image-taking angle of a camera) of FIG. 9.

The depression angle is an angle indicating the image-taking direction of a camera, and corresponds to the angle downward from the horizontal plane where the horizontal direction is 0°.

In FIG. 10, the processing example 1 of the movable-target-frame-area dividing unit 204 is an example of the movable-target-frame-area dividing processing where the movable target is a person.

The movable-target-frame-area dividing unit 204 divides the movable-target frame set by the movable-target-frame setting unit 202 on the basis of the size of the movable-target frame, the movable-target attribute=person determined by the movable-target-attribute determining unit 203, and, in addition, the camera image-taking angle (depression angle).

Note that area-dividing information, which is used to divide a movable-target frame on the basis of a movable-target-frame-size, a movable-target attribute, and the like, is registered in a table (attribute-corresponding movable-target-frame-dividing-information register table) prestored in the storage unit.

The movable-target-frame-area dividing unit 204 obtains divided-area-setting information, which is used to divide the movable-target frame where the movable-target attribute is a “person”, with reference to this table, and divides the movable-target frame on the basis of the obtained information.

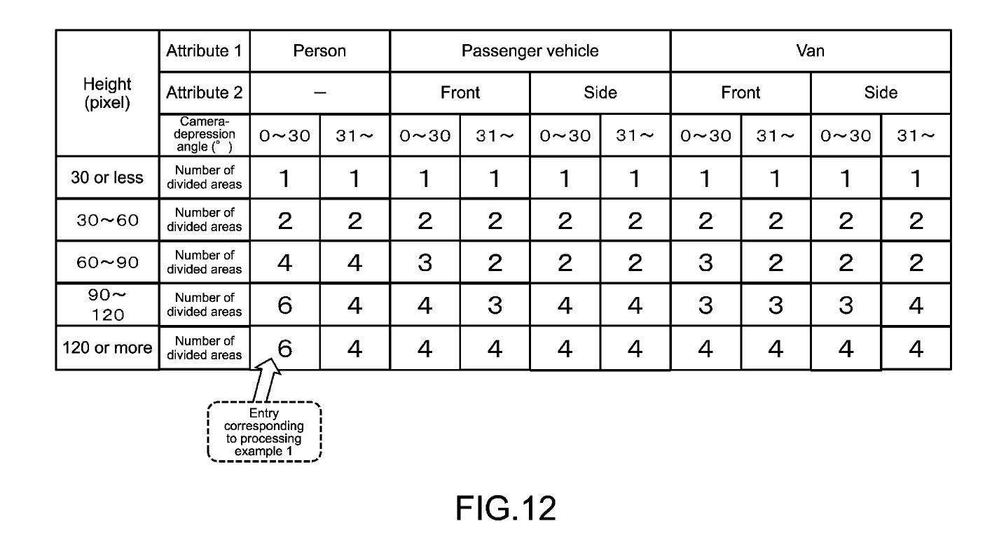

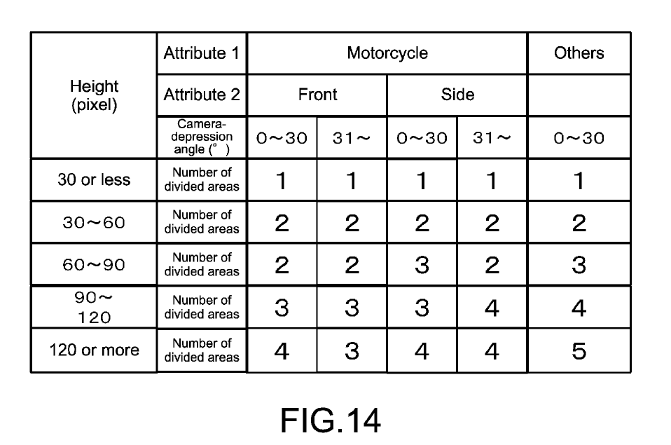

Each of FIG. 12 to FIG. 14 shows a specific example of the “attribute-corresponding movable-target-frame-dividing-information register table” stored in the storage unit of the camera 10.

Each of FIG. 12 to FIG. 14 is the “attribute-corresponding movable-target-frame-dividing-information register table” which defines the movable-target-frame dividing number where the movable-target attribute is each of the following attributes,
(1) person,
(2) passenger vehicle (front),
(3) passenger vehicle (side),
(4) van (front),
(5) van (side),
(6) bus (front),
(7) bus (side),
(8) truck (front),
(9) truck (side),
(10) motorcycle (front),
(11) motorcycle (side), and
(12) others.

The number of divided areas of each movable-target frame is defined on the basis of the twelve kinds of attributes and, in addition, on the basis of the size of a movable-target frame and the camera-depression angle.

Five kinds of movable-target-frame-size are defined as follows on the basis of the pixel size in the vertical direction of a movable-target frame,
(1) 30 pixels or less,
(2) 30 to 60 pixels,
(3) 60 to 90 pixels,
(4) 90 to 120 pixels, and
(5) 120 pixels or more.

Further, two kinds of camera-depression angle are defined as follows,
(1) 0 to 30°, and
(2) 31° or more.

In summary, the mode of dividing the movable-target frame is decided on the basis of the following three conditions,
(A) the attribute of the movable target in the movable-target frame,
(B) the movable-target-frame-size, and
(C) the camera-depression angle.

The movable-target-frame-area dividing unit 204 obtains the three kinds of information (A), (B), and (C), selects an appropriate entry from the “attribute-corresponding movable-target-frame-dividing-information register table” of each of FIG. 12 to FIG. 14 on the basis of the three kinds of obtained information, and decides an area-dividing mode for the movable-target frame.

Note that (A) the attribute of the movable target in the movable-target frame is obtained on the basis of the information determined by the movable-target-attribute determining unit 203.

(B) The movable-target-frame-size is obtained on the basis of the movable-target-frame setting information set by the movable-target-frame setting unit 202.

(C) The camera-depression angle is obtained on the basis of the camera-installation-status parameter 210 of FIG. 9, i.e., the camera-installation-status parameter 210 stored in the storage unit of the camera 10.

For example, in the processing example 1 of FIG. 10, the movable-target-frame-area dividing unit 204 obtains the following data,
(A) the attribute of the movable target in the movable-target frame=person,
(B) the movable-target-frame-size=150 pixels (length in vertical (y) direction), and
(C) the camera-depression angle=5 degrees.

The movable-target-frame-area dividing unit 204 selects an appropriate entry from the “attribute-corresponding movable-target-frame-dividing-information register table” of each of FIG. 12 to FIG. 14 on the basis of the obtained information.

The entry corresponding to the processing example 1 of FIG. 12 is selected.

In FIG. 12, the number of divided areas=6 is set for the entry corresponding to the processing example 1.

The movable-target-frame-area dividing unit 204 divides the movable-target frame into 6 areas on the basis of the data recorded in the entry corresponding to the processing example 1 of FIG. 12.

As shown in the processing example 1 of FIG. 10, the movable-target-frame-area dividing unit 204 divides the movable-target frame 251 into 6 areas in the vertical direction and sets the area 1 to the area 6.

For example, in the processing example 2 of FIG. 10, the movable-target-frame-area dividing unit 204 obtains the following data,
(A) the attribute of the movable target in the movable-target frame=bus (side),
(B) the movable-target-frame-size=100 pixels (length in vertical (y) direction), and
(C) the camera-depression angle=5 degrees.

The movable-target-frame-area dividing unit 204 selects an appropriate entry from the “attribute-corresponding movable-target-frame-dividing-information register table” of each of FIG. 12 to FIG. 14 on the basis of the obtained information.

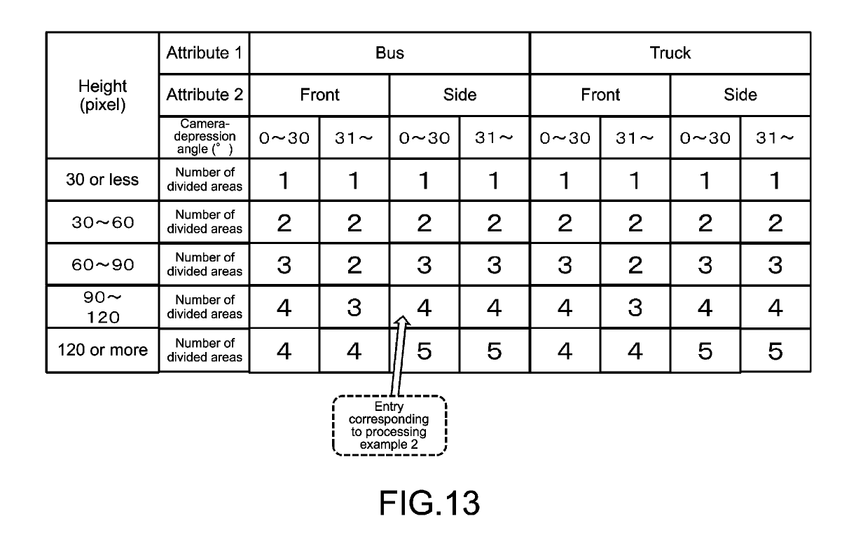

The entry corresponding to the processing example 2 of FIG. 13 is selected.

In FIG. 13, the number of divided areas=4 is set for the entry corresponding to the processing example 2.

The movable-target-frame-area dividing unit 204 divides the movable-target frame into 4 areas on the basis of the data recorded in the entry corresponding to the processing example 2 of FIG. 13.

As shown in the processing example 2 of FIG. 10, the movable-target-frame-area dividing unit 204 divides the movable-target frame 271 into 4 areas in the vertical direction and sets the area 1 to the area 4.

In summary, the movable-target-frame-area dividing unit 204 divides the movable-target frame set by the movable-target-frame setting unit 202 on the basis of the movable-target attribute determined by the movable-target-attribute determining unit 203, the movable-target-frame-size, and the depression angle of the camera.

Next, with reference to FIG. 11, the processing executed by the characteristic-amount-extracting-divided-area deciding unit 205 will be described.

The characteristic-amount-extracting-divided-area deciding unit 205 decides a divided area, from which a characteristic amount is to be extracted, from the one or more divided areas in the movable-target frame set by the movable-target-frame-area dividing unit 204. The characteristic amount is color information, for example.

Similar to the movable-target-frame-area dividing unit 204 that divides the movable-target frame into areas, the characteristic-amount-extracting-divided-area deciding unit 205 decides a divided area, from which a characteristic amount is to be extracted, with reference to the size of the movable-target frame set by the movable-target-frame setting unit 202 and the camera-installation-status parameter 210 of FIG. 9, specifically, the depression angle, i.e., the image-taking angle of the camera.

Note that a divided area, from which a characteristic amount is to be extracted, is registered in a table (characteristic-amount-extracting-divided-area information register table) prestored in the storage unit.

The characteristic-amount-extracting-divided-area deciding unit 205 decides a divided area, from which a characteristic amount is to be extracted, with reference to the table.

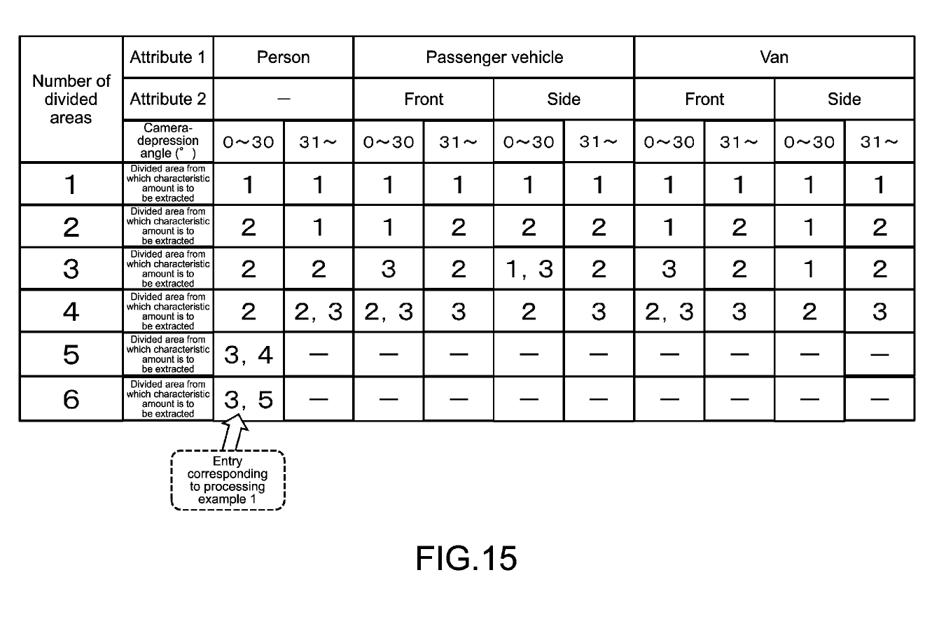

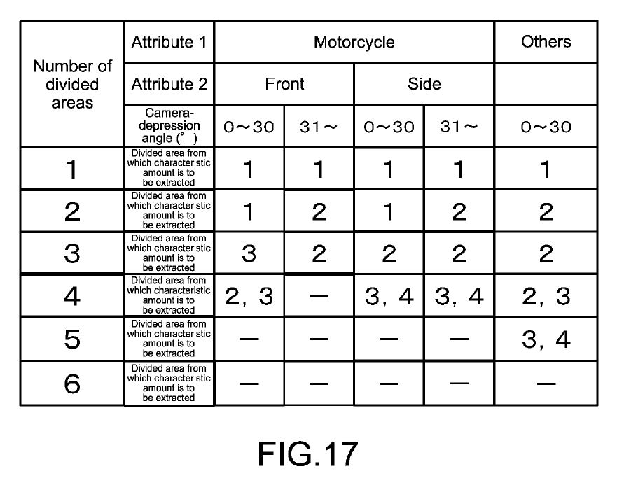

Each of FIG. 15 to FIG. 17 shows a specific example of the “characteristic-amount-extracting-divided-area information register table” stored in the storage unit of the camera 10.

Each of FIG. 15 to FIG. 17 shows the “characteristic-amount-extracting-divided-area information register table” which defines identifiers identifying an area, from which a characteristic amount is to be extracted, where the movable-target attribute is each of the following attributes,
(1) person,
(2) passenger vehicle (front),
(3) passenger vehicle (side),
(4) van (front),
(5) van (side),
(6) bus (front),
(7) bus (side),
(8) truck (front),
(9) truck (side),
(10) motorcycle (front),
(11) motorcycle (side), and
(12) others.

An area identifier identifying an area, from which a characteristic amount is to be extracted, is defined on the basis of the twelve kinds of attributes and, in addition, on the basis of the size of a movable-target frame and the camera-depression angle.

Five kinds of movable-target-frame-size are defined as follows on the basis of the pixel size in the vertical direction of a movable-target frame,
(1) 30 pixels or less,
(2) 30 to 60 pixels,
(3) 60 to 90 pixels,
(4) 90 to 120 pixels, and
(5) 120 pixels or more.

Further, two kinds of camera-depression angle are defined as follows,
(1) 0 to 30°, and
(2) 31° or more.

In summary, an area, from which a characteristic amount is to be extracted, is decided on the basis of the following three conditions,
(A) the attribute of the movable target in the movable-target frame,
(B) the movable-target-frame-size, and
(C) the camera-depression angle.

The characteristic-amount-extracting-divided-area deciding unit 205 obtains the three kinds of information (A), (B), and (C), selects an appropriate entry from the “characteristic-amount-extracting-divided-area information register table” of each of FIG. 15 to FIG. 17 on the basis of the three kinds of obtained information, and decides a divided area from which a characteristic amount is to be extracted.

Note that (A) the attribute of the movable target in the movable-target frame is obtained on the basis of the information determined by the movable-target-attribute determining unit 203.
(B) The movable-target-frame-size is obtained on the basis of the movable-target-frame setting information set by the movable-target-frame setting unit 202.
(C) The camera-depression angle is obtained on the basis of the camera-in-stallation-status parameter 210 of FIG. 9, i.e., the camera-installation-status parameter 210 stored in the storage unit of the camera 10.

For example, in the processing example 1 of FIG. 11, the characteristic-amount-extracting-divided-area deciding unit 205 obtains the following data,
(A) the attribute of the movable target in the movable-target frame=person,
(B) the movable-target-frame-size=150 pixels (length in vertical (y) direction), and
(C) the camera-depression angle=5 degrees.

The characteristic-amount-extracting-divided-area deciding unit 205 selects an appropriate entry from the “characteristic-amount-extracting-divided-area information register table” of each of Fig. FIG. 15 to FIG. 17 on the basis of the obtained information.

The entry corresponding to the processing example 1 of FIG. 15 is selected.

In FIG. 15, the divided area identifiers=3, 5 are set for the entry corresponding to the processing example 1.

The characteristic-amount-extracting-divided-area deciding unit 205 decides the divided areas 3, 5 as divided areas from which characteristic amounts are to be extracted on the basis of the data recorded in the entry corresponding to the processing example 1 of FIG. 15.

As shown in the processing example 1 of FIG. 11, the characteristic-amount-extracting-divided-area deciding unit 205 decides the areas 3, 5 of the divided areas 1 to 6 of the movable-target frame 251 as characteristic-amount-extracting-areas.

For example, in the processing example 2 of FIG. 11, the characteristic-amount-extracting-divided-area deciding unit 205 obtains the following data,
(A) the attribute of the movable target in the movable-target frame=bus (side),
(B) the movable-target-frame-size=100 pixels (length in vertical (y) direction), and
(C) the camera-depression angle=5 degrees.

The characteristic-amount-extracting-divided-area deciding unit 205 selects an appropriate entry from the “characteristic-amount-extracting-divided-area information register table” of each of FIG. 15 to FIG. 17 on the basis of the obtained information.

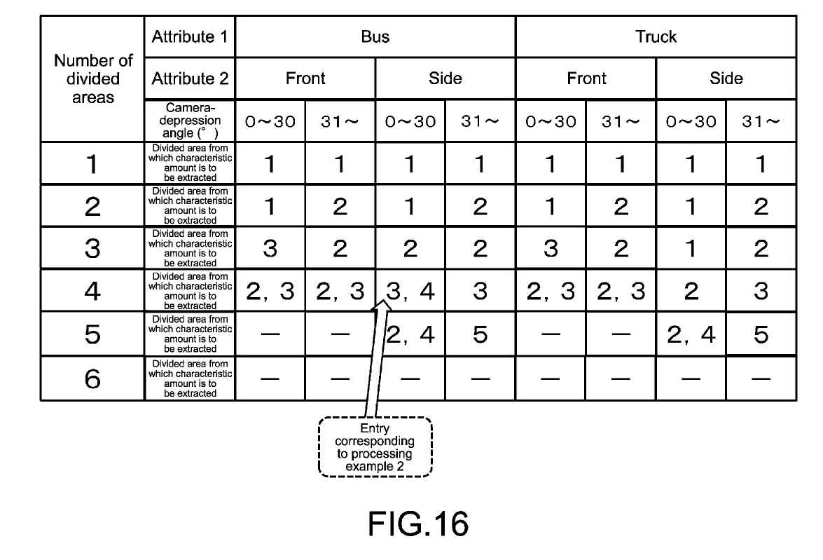

The entry corresponding to the processing example 2 of FIG. 16 is selected.

In FIG. 16, the divided area identifiers=3, 4 are set for the entry corresponding to the processing example 2.

The characteristic-amount-extracting-divided-area deciding unit 205 decides the divided areas 3, 4 as divided areas from which characteristic amounts are to be extracted on the basis of the data recorded in the entry corresponding to the processing example 2 of FIG. 16.

As shown in the processing example 2 of FIG. 11, the characteristic-amount-extracting-divided-area deciding unit 205 decides the areas 3, 4 of the divided areas 1 to 4 set for the movable-target frame 271 as characteristic-amount-extracting-areas.

In summary, the characteristic-amount-extracting-divided-area deciding unit 205 decides a divided area/divided areas from which a characteristic amount/characteristic amounts is/are to be extracted from the divided areas in the movable-target frame set by the movable-target-frame-area dividing unit 204.

The characteristic-amount-extracting-divided-area deciding unit 205 decides a divided area/divided areas on the basis of the movable-target attribute determined by the movable-target-attribute determining unit 203, the movable-target-frame-size, and the depression angle of the camera.

Next, the divided-area characteristic-amount extracting unit 206 extracts a characteristic amount from a characteristic-amount-extracting-divided-area decided by the characteristic-amount-extracting-divided-area deciding unit 205.

With reference to FIG. 11, an example of the processing executed by the divided-area characteristic-amount extracting unit 206 will be described specifically.

Note that, in this example, color information is obtained as a characteristic amount.

For example, in the processing example 1 of FIG. 11, the movable target in the movable-target frame 251 has the movable-target attribute=person, and the characteristic-amount-extracting-divided-area deciding unit 205 decides the areas 3, 5 from the divided areas 1 to 6 of the movable-target frame 251 as characteristic-amount-extracting-areas.

In the processing example 1, the divided-area characteristic-amount extracting unit 206 obtains color information on the movable target as characteristic amounts from the divided areas 3, 5.

In the processing example 1 of FIG. 11, the divided-area characteristic-amount extracting unit 206 obtains characteristic amounts of the areas 3, 5 as follows. The divided-area characteristic-amount extracting unit 206 obtains the color information=“red” on the divided area 3 of the movable-target frame 251 as the characteristic amount of the area 3. Further, the divided-area characteristic-amount extracting unit 206 obtains the color information=“black” on the divided area 5 of the movable-target frame 251 as the characteristic amount of the area 5.

The obtained information is stored in the storage unit.

Note that the processing example 1 of FIG. 11 shows a configurational example in which the divided-area characteristic-amount extracting unit 206 obtains only one kind of color information from one area. However, in some cases, a plurality of colors are contained in one area, for example, the pattern of clothes contains a plurality of different colors, etc. In such a case, the divided-area characteristic-amount extracting unit 206 obtains information on a plurality of colors in one area, and stores the information on the plurality of colors in the storage unit as color information corresponding to this area.

Further, in the processing example 2 of FIG. 11, the movable target in the movable-target frame 271 has the movable-target attribute=bus (side), and the characteristic-amount-extracting-divided-area deciding unit 205 decides the areas 3, 4 from the divided areas 1 to 4 of the movable-target frame 271 as characteristic-amount-extracting-areas.

In the processing example 2, the divided-area characteristic-amount extracting unit 206 obtains color information on the movable target as characteristic amounts from the divided areas 3, 4.

In the processing example 2 of FIG. 11, the divided-area characteristic-amount extracting unit 206 obtains characteristic amounts of the areas 3, 4 as follows.

The divided-area characteristic-amount extracting unit 206 obtains the color information=“white” on the divided area 3 of the movable-target frame 271 as the characteristic amount of the area 3. Further, the divided-area characteristic-amount extracting unit 206 obtains the color information=“green” on the divided area 4 of the movable-target frame 271 as the characteristic amount of the area 4.

The obtained information is stored in the storage unit.

Note that, similar to the processing example 1, the processing example 2 of FIG. 11 shows a configurational example in which the divided-area characteristic-amount extracting unit 206 obtains only one kind of color information from one area. However, in some cases, a plurality of colors are contained in one area. In such a case, the divided-area characteristic-amount extracting unit 206 obtains information on a plurality of colors in one area, and stores the information on the plurality of colors in the storage unit as color information corresponding to this area.

In FIG. 9, next, the metadata recording-and-outputting unit 207 generates the metadata 220 on the movable-target object, to which the movable-target frame is set, and outputs the metadata 220. The metadata recording-and-outputting unit 207 outputs the metadata 220 to the storage apparatus (server) 20 of FIG. 8. The storage apparatus (server) 20 of FIG. 8 stores the metadata 220 in the metadata storage unit 121.

With reference to FIG. 11, a specific example of metadata generated by the metadata recording-and-outputting unit 207 will be described.

In the processing example 1 of FIG. 11, the movable target in the movable-target frame 251 has the movable-target attribute=person, the number of divided areas of the movable-target frame 251 is 6, and color information on the movable target is obtained from the divided areas 3, 5 as a characteristic amount.

As shown in FIG. 11, in the processing example 1, the metadata recording-and-outputting unit 207 generates metadata corresponding to the object including the following recorded data,
(1) attribute=person,
(2) area-dividing mode=dividing into 6 in vertical direction,
(3) characteristic-amount obtaining-area identifiers=3, 5,
(4) divided-area characteristic-amount=(area 3=red, area 5=black), and
(5) movable-target-object-detected-image frame information.

The metadata recording-and-outputting unit 207 generates metadata including the above-mentioned information (1) to (5), and stores the generated metadata as metadata corresponding to the movable-target object in the storage apparatus (server) 20. Note that the movable-target-object-detected-image frame information is identifier information identifying the image frame whose metadata is generated, i.e., the image frame in which the movable target is detected. Specifically, camera identifier information on the camera that took the image, image-taking date/time information, and the like are recorded.

The metadata is stored in the server as data corresponding to the image frame in which the movable-target object is detected.

Further, in the processing example 2 of FIG. 11, the movable target in the movable-target frame 271 has the movable-target attribute=bus (side), the number of divided areas of the movable-target frame 271 is 4, and color information on the movable target is obtained from the divided areas 3, 4 as characteristic amounts.

As shown in FIG. 11, in the processing example 2, the metadata recording-and-outputting unit 207 generates metadata corresponding to the object 2 including the following recorded data,
(1) attribute=bus (side),
(2) area-dividing mode=dividing into 4 in vertical direction,
(3) characteristic-amount obtaining-area identifiers=3, 4,
(4) divided-area characteristic-amount=(area 3=white, area 4=green), and
(5) movable-target-object-detected-image frame information.

The metadata recording-and-outputting unit 207 generates metadata including the above-mentioned information (1) to (5), and stores the generated metadata as metadata corresponding to the movable-target object 2 in the storage apparatus (server) 20. Note that the movable-target-object-detected-image frame information is identifier information identifying the image frame whose metadata is generated, i.e., the image frame in which the movable target is detected. Specifically, camera identifier information on the camera that took the image, image-taking date/time information, and the like are recorded.

The metadata is stored in the server as data corresponding to the image frame in which the movable-target object 2 is detected.

In summary, the metadata generating unit 111 of the camera 10 of FIG. 8 generates metadata of each of movable-target objects in the images taken by the camera, and sends the generated metadata to the storage apparatus (server) 20. The storage apparatus (server) 20 stores the metadata in the metadata storage unit 121.

As described above with reference to FIG. 12 to FIG. 17, the metadata generating unit 111 of the camera 10 decides the mode of dividing the movable-target frame and the characteristic-amount-extracting-divided-area on the basis of the following three conditions,
(A) the attribute of the movable target in the movable-target frame,
(B) the movable-target-frame-size, and
(C) the camera-depression angle.

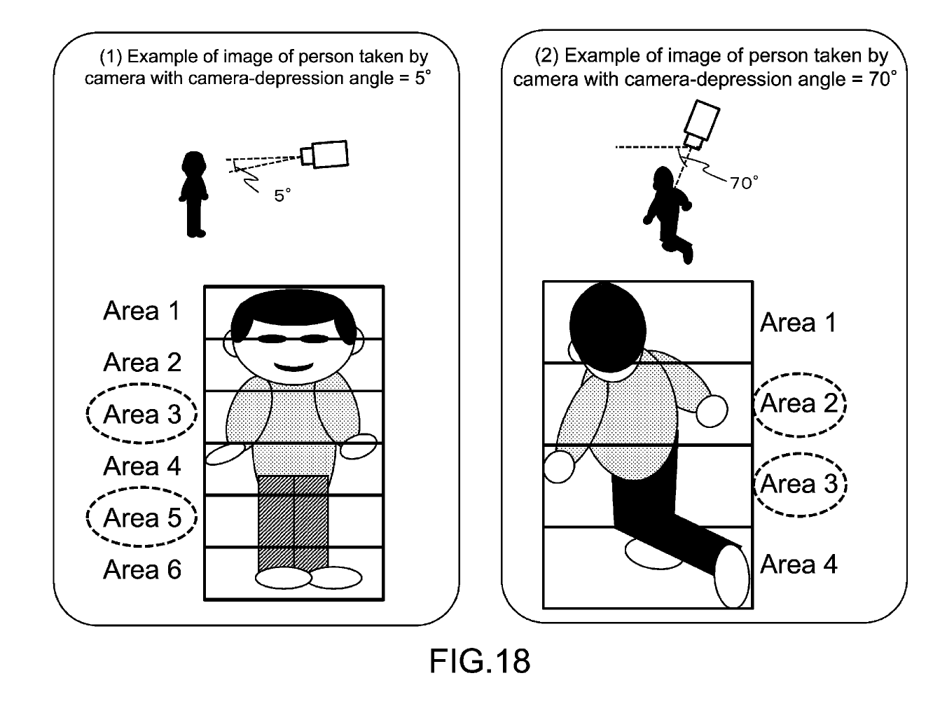

With reference to FIG. 18, one of the above-mentioned conditions, i.e., the camera-depression angle, will be described.

As described above, the camera-depression angle is an angle indicating the image-taking direction of a camera, and corresponds to the angle downward from the horizontal plane where the horizontal direction is 0°.

FIG. 18 shows image-taking modes in which two different camera-depression angles are set, and setting examples of modes of dividing the movable-target frame, the movable-target frame being clipped from a taken image, and characteristic-amount-extracting-areas.

The example (1) of FIG. 18 shows image-taking modes in which the camera-depression angle=5° is set, and setting examples of a mode of dividing the movable-target frame and a characteristic-amount-extracting-area.

This example corresponds to the processing example 1 described with reference to FIG. 9 to FIG. 17. In this example, the number of dividing the movable-target frame is 6 as shown in the entry corresponding to the processing example 1 of the “attribute-corresponding movable-target-frame-dividing-information register table” of FIG. 12, and the characteristic-amount-extracting-areas are the area 3 and the area 5 as shown in the entry corresponding to the processing example 1 of the “characteristic-amount-extracting-divided-area information register table” of FIG. 15.

Since the movable-target frame is divided and the characteristic-amount-extracting-areas are set as described above, it is possible to separately discern the color of clothes of the upper-body of a person and the color of clothes of the lower-body of him, and to obtain information thereon separately.

Meanwhile, the example (2) of FIG. 18 shows image-taking modes in which the camera-depression angle=70° is set, and setting examples of a mode of dividing the movable-target frame and a characteristic-amount-extracting-area.

This example corresponds to the entry immediately at the right of the entry corresponding to the processing example 1 of the “attribute-corresponding movable-target-frame-dividing-information register table” of FIG. 12. The number of dividing the movable-target frame is 4 as shown in this entry, in which the registered data is the number of divided areas=4.

Further, in this example, the divided area identifiers=2, 3 are registered in an entry of the “characteristic-amount-extracting-divided-area information register table” of FIG. 15, the entry being determined by
attribute=person,
number of divided areas=4, and
camera-depression angle=31° or more.

The characteristic-amount-extracting-areas are the area 2 and the area 3 as shown in this entry.

Since the movable-target frame is divided and the characteristic-amount-extracting-areas are set as described above, it is possible to separately discern the color of clothes of the upper-body of a person and the color of clothes of the lower-body of him, and to obtain information thereon separately.

In summary, the area-dividing mode of a movable-target frame and characteristic-amount-extracting-areas are changed on the basis of a camera-depression angle, i.e., a setting status of a camera. According to this configuration, a user is capable of understanding the characteristics of a movable target better.

Note that, in the above-mentioned example, the table used to decide the mode of dividing the movable-target frame, i.e., the “attribute-corresponding movable-target-frame-dividing-information register table” of each of FIG. 12 to FIG. 14, and the table used to decide the divided area from which a characteristic amount is to be extracted, i.e., the “characteristic-amount-extracting-divided-area information register table” of each of FIG. 15 to FIG. 17 are used. In short, two kinds of independent tables are used. Alternatively, one table including those two tables may be used. It is possible to decide the mode of dividing the movable-target frame and decide the characteristic-amount-extracting-divided-area by using one table.

Further, in the table of each of FIG. 12 to FIG. 17, processing is sorted only on the basis of height information as the size of a movable-target frame. In an alternative configuration, processing may be sorted also on the basis of the width or area of a movable-target frame.

Also, a vehicle-type other than the vehicle-type shown in the table of each of FIG. 12 to FIG. 17 may be set. Further, data is set for a vehicle only distinguishing between front and side. In an alternative configuration, data may also be set in back or diagonal direction.

Further, the camera-depression angle is sorted into two ranges, i.e., 30° or less and 31° or more. In an alternative configuration, the camera-depression angle may be sorted into three or more ranges.

### 5. Sequence of Generating Metadata by Metadata Generating Unit of Camera (Image Processing Apparatus)

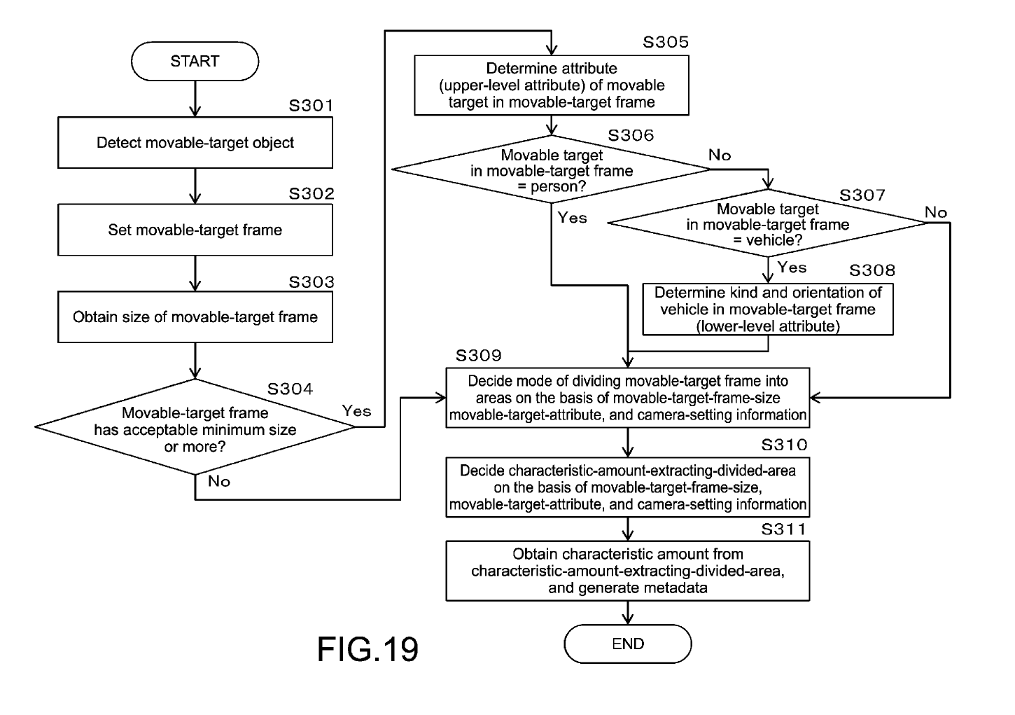

Next, with reference to the flowchart of FIG. 19, the sequence of the processing executed by the metadata generating unit 111 of the camera (image processing apparatus) 10 will be described.

Note that the metadata generating unit executes the processing of the flow of FIG. 19 on the basis of a program stored in the storage unit of the camera, for example. The metadata generating unit is a data processing unit including a CPU and other components and having functions to execute programs.

Hereinafter, the processing of each of the steps of the flowchart of FIG. 19 will be described in series.

(Step S301)

Firstly, in Step S301, the metadata generating unit of the camera detects a movable-target object from images taken by the camera.

This processing is the processing executed by the movable-target object detecting unit 201 of FIG. 9. This movable-target object detection processing is executed by using a known movable-target detecting method including, for example, detecting a movable target on the basis of pixel value differences of serially-taken images or the like.

(Step S302)

Next, in Step S302, a movable-target frame is set for the movable-target object detected in Step S301.

This processing is the processing executed by the movable-target-frame setting unit 202 of FIG. 9.

As described above with reference to FIG. 10, a rectangular frame surrounding the entire movable target is set as the movable-target frame.

(Steps S303 to S308)

Next, the processing of Steps S303 to S308 is the processing executed by the movable-target-attribute determining unit 203 of FIG. 9.

Firstly, in Step S303, the movable-target-attribute determining unit 203 obtains the size of the movable-target frame set for the movable target whose movable-target attribute is to be determined. In Step S304, the movable-target-attribute determining unit 203 determines if the movable-target frame has the acceptable minimum size or more or not.

As described above, next, the movable-target-attribute determining unit 203 determines the attribute (specifically, a person or a vehicle, in addition, the kind of vehicle, e.g., a passenger vehicle, a bus, a truck, etc.) of the movable target in the movable-target frame set by the movable-target-frame setting unit 202.

Further, where the attribute of the movable target is a vehicle, the movable-target-attribute determining unit 203 determines whether the vehicle faces front or side.

The movable-target-attribute determining unit 203 determines such an attribute by checking the movable target against, for example, library data preregistered in the storage unit (database) of the camera 10. The library data records characteristic information on shapes of various movable targets such as persons, passenger vehicles, and buses.

However, it is difficult to determine the attribute accurately where the movable-target-frame-size is too small. In Steps S303 to S304, it is determined if the size of the movable-target frame is the acceptable minimum size or more to determine the attribute accurately or not. Where it is less than the acceptable size (determined in Step S304=No), the processing proceeds to Step S309 without executing the attribute determination processing.

Note that where the movable-target-frame-size is small and is less than the acceptable minimum size, the processing is executed by using the tables of FIG. 12 to FIG. 17, in which the attribute=others.

Meanwhile, where it is determined that the size of the movable-target frame set in Step S302 is the acceptable minimum size or more to determine the attribute accurately, the processing proceeds to Step S305, and the upper-level attribute of the movable target in the movable-target frame is to be determined.

In Steps S305 to S307, firstly, the upper-level attribute of the movable target is determined.

As the upper-level attribute, it is discerned if the movable target is a person or not.

If it is determined that the movable target is a person (S306=Yes), the processing proceeds to Step S309.

Meanwhile, if it is determined that the movable target is not a person (S306=No), the processing proceeds to Step S307.

If it is determined that the movable target is not a person (S306=No), in Step S307, it is further discerned if the movable target is a vehicle or not.

If it is determined that the movable target is a vehicle (S307=Yes), the processing proceeds to Step S308.

Meanwhile, if it is determined that the movable target is not a vehicle (S307=No), the processing proceeds to Step S309.

If it is determined that the movable target is a vehicle (S307=Yes), the processing proceeds to Step S308. It is further determined the kind and the orientation of the vehicle, i.e., the movable target in the movable-target frame, as the movable-target attribute (lower-level attribute).

Specifically, it is determined if the vehicle is, for example, a passenger vehicle (front), a passenger vehicle (side), a van (front), a van (side), a bus (front), a bus (side), a truck (front), a truck (side), a motorcycle (front), or a motorcycle (side).

(Step S309)

Next, the processing of Step S309 is the processing executed by the movable-target-frame-area dividing unit 204 of FIG. 9.

The processing of Step S309 is started where
(a) in Step S304, it is determined that the size of the movable-target frame is less than the acceptable minimum size,
(b) in Steps S306 to S307, it is determined that the movable-target attribute is not a person nor a vehicle,
(c) in Step S306, it is determined that the movable-target attribute is a person, or
(d) in Step S308, the attributes of the kind of the vehicle and its orientation are determined.

Where the processing of any one of the above-mentioned (a) to (d) is executed, the processing of Step S309 is executed. In other words, the movable-target-frame-area dividing unit 204 of FIG. 9 divides the movable-target frame set by the movable-target-frame setting unit 202 on the basis of the movable-target attribute and the like.

Note that the movable-target-frame-area dividing unit 204 divides the movable-target frame with reference to the size of the movable-target frame set by the movable-target-frame setting unit 202 and to the camera-installation-status parameter 210 (specifically, a depression angle, i.e., an image-taking angle of a camera) of FIG. 9.

Specifically, the movable-target-frame-area dividing unit 204 divides the movable-target frame with reference to the “attribute-corresponding movable-target-frame-dividing-information register table” described with reference to each of FIG. 12 to FIG. 14.

The movable-target-frame-area dividing unit 204 extracts an appropriate entry from the “attribute-corresponding movable-target-frame-dividing-information register table” described with reference to each of FIG. 12 to FIG. 14 on the basis of the movable-target attribute, the movable-target-frame-size, and the depression angle of the image-taking direction of the camera, and decides the dividing mode.

As described above with reference to each of FIG. 12 to FIG. 14, the mode of dividing the movable-target frame is decided on the basis of the following three conditions,
(A) the attribute of the movable target in the movable-target frame,
(B) the movable-target-frame-size, and
(C) the camera-depression angle.

The movable-target-frame-area dividing unit 204 obtains the three kinds of information (A), (B), and (C), selects an appropriate entry from the “attribute-corresponding movable-target-frame-dividing-information register table” of each of FIG. 12 to FIG. 14 on the basis of the three kinds of obtained information, and decides an area-dividing mode for the movable-target frame.

(Step S310)

Next, the processing of Step S310 is the processing executed by the characteristic-amount-extracting-divided-area deciding unit 205 of FIG. 9.

The characteristic-amount-extracting-divided-area deciding unit 205 decides a divided area, from which a characteristic amount is to be extracted, from the one or more divided areas in the movable-target frame set by the movable-target-frame-area dividing unit 204. The characteristic amount is color information, for example.

Similar to the movable-target-frame-area dividing unit 204 that divides the movable-target frame into areas, the characteristic-amount-extracting-divided-area deciding unit 205 decides a divided area, from which a characteristic amount is to be extracted, with reference to the size of the movable-target frame set by the movable-target-frame setting unit 202 and the camera-installation-status parameter 210 of FIG. 9, specifically, the depression angle, i.e., the image-taking angle of the camera.

Specifically, as described above with reference to each of FIG. 15 to FIG. 17, the characteristic-amount-extracting-divided-area deciding unit 205 decides a divided area from which a characteristic amount is to be extracted with reference to the “characteristic-amount-extracting-divided-area information register table”.

The characteristic-amount-extracting-divided-area deciding unit 205 extracts an appropriate entry from the “characteristic-amount-extracting-divided-area information register table” described with reference to each of FIG. 15 to FIG. 17 on the basis of the movable-target attribute, the movable-target-frame-size, and the depression angle of the image-taking direction of the camera, and decides a divided area from which a characteristic amount is extracted.

As described above with reference to each of FIG. 15 to FIG. 17, a divided area, from which a characteristic amount is to be extracted, is decided on the basis of the following three conditions,
(A) the attribute of the movable target in the movable-target frame,
(B) the movable-target-frame-size, and
(C) the camera-depression angle.

The characteristic-amount-extracting-divided-area deciding unit 205 obtains the three kinds of information (A), (B), and (C), selects an appropriate entry from the “characteristic-amount-extracting-divided-area information register table” of each of FIG. 15 to FIG. 17 on the basis of the three kinds of obtained information, and decides a divided area from which a characteristic amount is to be extracted.

(Step S311)

Finally, the processing of Step S311 is the processing executed by the divided-area characteristic-amount extracting unit 206 and the metadata recording-and-outputting unit 207 of FIG. 9.

The divided-area characteristic-amount extracting unit 206 extracts a characteristic amount from a characteristic-amount-extracting-divided-area decided by the characteristic-amount-extracting-divided-area deciding unit 205.

As described above with reference to FIG. 11, the divided-area characteristic-amount extracting unit 206 obtains a characteristic amount, e.g., color information on the movable target, from the characteristic-amount-extracting-divided-area decided by the characteristic-amount-extracting-divided-area deciding unit 205 on the basis of the movable-target attribute of the movable-target frame and the like. As described above with reference to FIG. 11, the metadata recording-and-outputting unit 207 generates metadata corresponding to the object including the following recorded data,
(1) attribute,
(2) area-dividing mode,
(3) characteristic-amount obtaining-area identifier,
(4) divided-area characteristic-amount, and
(5) movable-target-object-detected-image frame information

The metadata recording-and-outputting unit 207 generates metadata including the above-mentioned information (1) to (5), and stores the generated metadata as metadata corresponding to the movable-target object in the storage apparatus (server) 20. Note that the movable-target-object-detected-image frame information is identifier information identifying the image frame whose metadata is generated, i.e., the image frame in which the movable target is detected. Specifically, camera identifier information on the camera that took the image, image-taking date/time information, and the like are recorded.

The metadata is stored in the server as data corresponding to the image frame in which the movable-target object is detected.

### 6. Processing of Searching for and Tracking Object by Search Apparatus (Information Processing Apparatus)

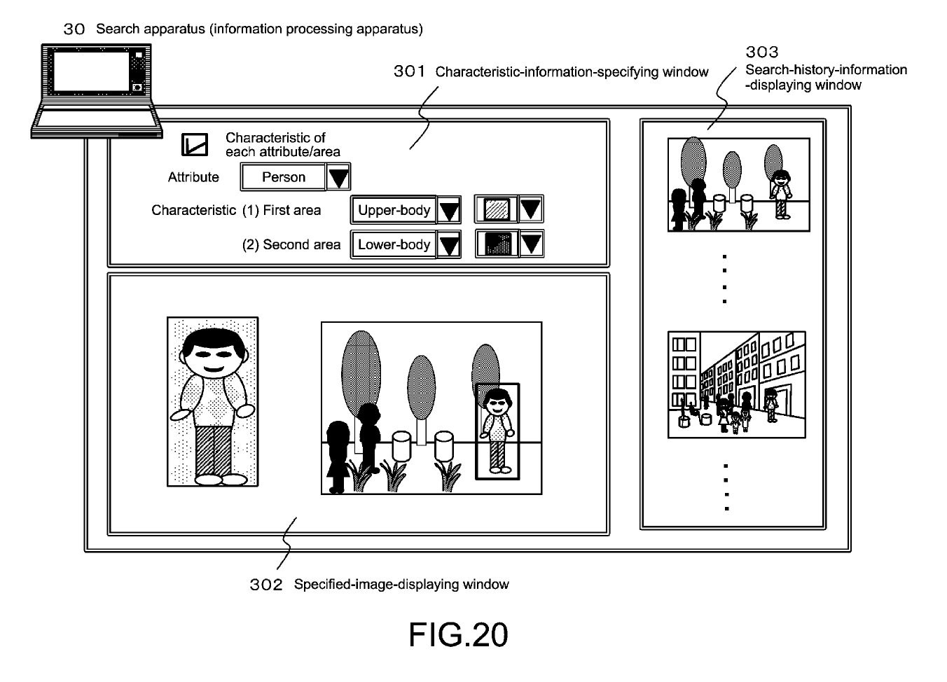

Next, with reference to FIG. 20 and the following figures, an example of the processing of searching for and tracking a certain person or the like by using the search apparatus (information processing apparatus) 30 of FIG. 1 will be described. Further, an example of display data (user interface) displayed on the display unit of the search apparatus (information processing apparatus) 30 at the time of this processing will be described.

As described above, the metadata generating unit 111 of the camera 10 determines the movable-target attribute of the movable-target object detected from an image, and divides the movable-target frame on the basis of the movable-target attribute, the movable-target-frame-size, the camera-depression angle, and the like. Further, the metadata generating unit 111 decides a divided area from which a characteristic amount is to be extracted, extracts a characteristic amount from the decided divided area, and generates metadata.

Since the search apparatus (information processing apparatus) 30 of FIG. 1 searches for an object by using the metadata, the search apparatus (information processing apparatus) 30 is capable of searching for an object on the basis of the object attribute in the optimum way.

In other words, the data processing unit 132 of the search apparatus (information processing apparatus) 30 of FIG. 8 searches for an object on the basis of a characteristic amount of a characteristic-amount-extracting-area decided on the basis of the attribute of an object-to-be-searched-for.

For example, the data processing unit 132 searches for an object on the basis of a characteristic amount of a characteristic-amount-extracting-area decided on the basis of the attribute of an object-to-be-searched-for, i.e., a person or a vehicle. Further, where the attribute of an object-to-be-searched-for is a vehicle, the data processing unit 132 searches for an object on the basis of a characteristic amount of a characteristic-amount-extracting-area decided on the basis of the vehicle-type and the orientation of the vehicle.

Further, the data processing unit 132 searches for an object on the basis of a characteristic amount of the characteristic-amount-extracting-area decided on the basis of at least one of information on the size of the movable-target object in the searched image and the image-taking-angle information on the camera.

With reference to FIG. 20 and the following figures, data displayed on the display unit of the search apparatus (information processing apparatus) 30 when the search apparatus (information processing apparatus) 30 searches for an object will be described.

FIG. 20 is a diagram showing an example of data displayed on the display unit of the search apparatus (information processing apparatus) 30 of the system of FIG. 1.

A user who searches for and tracks an object by using the search apparatus (information processing apparatus) 30 inputs characteristic information on the object-to-be-searched-for-and-tracked in the characteristic-information-specifying window 301.

As shown in FIG. 20, the characteristic-information-specifying window 301 is configured to be capable of specifying the attribute of the object-to-be-searched-for and the characteristic for each area.

An image including an object-to-be-searched-for, which is extracted by searching a previously-taken-image for the object or searching by a user, is displayed in the specified-image-displaying window 302. The image including the object-to-be-searched-for, an enlarged image of the object-to-be-searched-for extracted from the image, and the like are displayed in the specified-image-displaying window 302.

Previous search history information, e.g., image data extracted in previous search processing, is displayed in the search-history-information-displaying window 303. Note that the display data of FIG. 20 is an example, and various data display modes other than that are available.

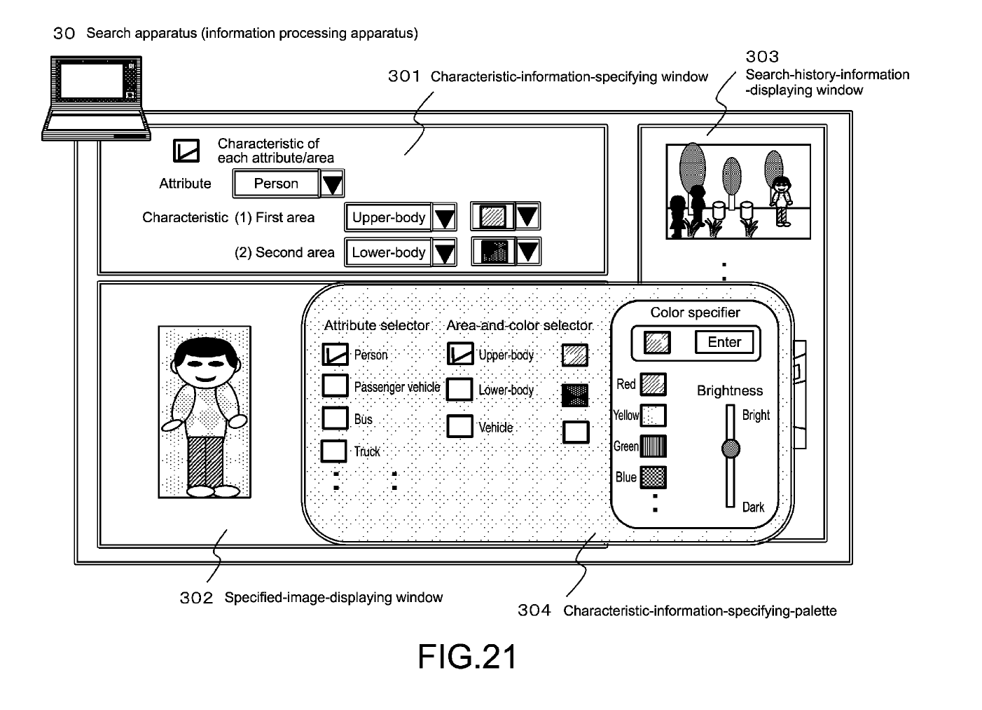

For example, a check-mark is input in a box for selecting characteristics of an attribute and an area of the characteristic-information-specifying window 301 in order to specify characteristics of an attribute and an area of an object-to-be-searched-for in the characteristic-information-specifying window 301 of FIG. 20. Then, the characteristic-information-specifying-palette 304 of FIG. 21 is displayed. A user can specify the attribute and the characteristic (color, etc.) of each area by using the palette.

As shown in FIG. 21, the characteristic-information-specifying-palette 304 has the following kinds of information input areas,
(a) attribute selector,
(b) area-and-color selector, and
(b) color specifier.

(a) The attribute selector is an area for specifying an attribute of an object to be searched for. Specifically, as shown in FIG. 20, the attribute selector specifies attribute information on an object-to-be-searched-for, i.e., if an object-to-be-searched-for is a person, a passenger vehicle, a bus, or the like.

In the example of FIG. 20, a check-mark is input for a person, which means that a person is set for an object-to-be-searched-for.

(b) The area-and-color selector is an area for specifying a color of each area of an object-to-be-searched-for as characteristic information on the object-to-be-searched-for. For example, where an object-to-be-searched-for is a person, the area-and-color selector is configured to set a color of an upper-body and a color of a lower-body separately.

According to the present disclosure, in order to search for an object, as described above, each characteristic amount (color, etc.) of each divided area of a movable-target frame is obtained. The area-and-color selector is capable of specifying each color to realize this processing.

(c) The color specifier is an area for setting color information used to specify color of each area by the area-and-color selector. The color specifier is configured to be capable of specifying a color such as red, yellow, and green, and then specifying the brightness of the color. Where a check-mark is input for any one item of (b) the area-and-color selector, then (c) the color specifier is displayed, and it is possible to specify a color for the checked item.

For example, a user wants to search for “a person with a red T-shirt and black trousers”. Then, firstly, the user selects “person” as the attribute of the object to be searched for in (b) the area-and-color selector. Next, the user specifies the area and the color of the object to be searched for. The user checks “upper-body”, and then he can specify the color in (c) the color specifier.

Since the person to be searched for wears “a red T-shirt”, the user selects and enters the red color, and then the right side of “upper-body” is colored red. Similarly, the user selects “lower-body” and specifies black for “black trousers”.

Note that, in the example of (b) the area-and-color selector of FIG. 21, only one color is specified for each area. Alternatively, a plurality of colors may be specified. For example, where the person wears a red T-shirt and a white coat, then the user additionally selects white for “upper-body”. Then the right side of “upper-body” is colored white next to red, in addition. The characteristic-information-specifying window 301 displays the attribute and the characteristics (colors) for the respective areas, which are specified by using the characteristic-information-specifying-palette 304, i.e., displays the specifying information in the respective areas.

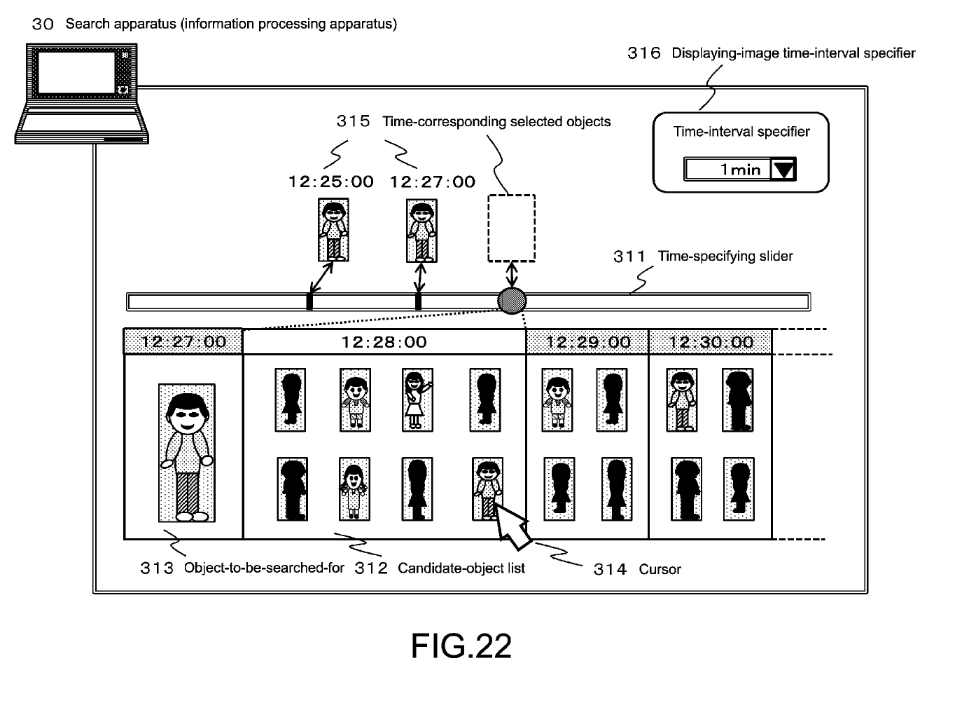

FIG. 22 is a diagram showing an example of displaying a result of search processing.

The time-specifying slider 311 and the candidate-object list 312 are displayed. The time-specifying slider 311 is operable by a user. The candidate-object list 312 displays candidate objects, which are obtained by searching the images taken by the cameras around the time specified by the user by using the time-specifying slider 311.

The candidate-object list 312 is a list of thumbnail images of objects, whose characteristic information is similar to the characteristic information specified by the user.

Note that the candidate-object list 312 displays a plurality of candidate objects for each image-taking time. The display order is determined on the basis of the priority calculated with reference to similarity to characteristic information specified by the user and other information, for example.

The priority may be calculated on the basis of, for example, the processing described above with reference to the flowchart of FIG. 7.

An image of the object-to-be-searched-for 313, which is now being searched for, is displayed at the left of the candidate-object list 312. The images taken at a predetermined time interval are searched for candidate objects, which are determined to be similar to the object-to-be-searched-for 313. A list of the candidate objects is generated, and thumbnail images (reduced-size image) of the candidate objects in the list are displayed.

The user determines each thumbnail image in the candidate-object list 312 as the object-to-be-searched-for, and can select the determined thumbnail images by using the cursor 314. The selected images are displayed as the time-corresponding selected objects 315 at the top of the time-specifying slider 311.

Note that the user can specify the time interval, at which the images displayed in the candidate-object list 312 are taken, at will by using the displaying-image time-interval specifier 316.

The number of candidate objects taken at the image-taking time, which is the same as the time specified by the user, displayed in the candidate-object list 312 is the largest. The number of candidate objects taken at the image-taking time, which is different from the time specified by the user, displayed in the candidate-object list 312 is less. Since the candidate-object list 312 is displayed as described above, the user can find out the object-to-be-searched-for for each time without fail.

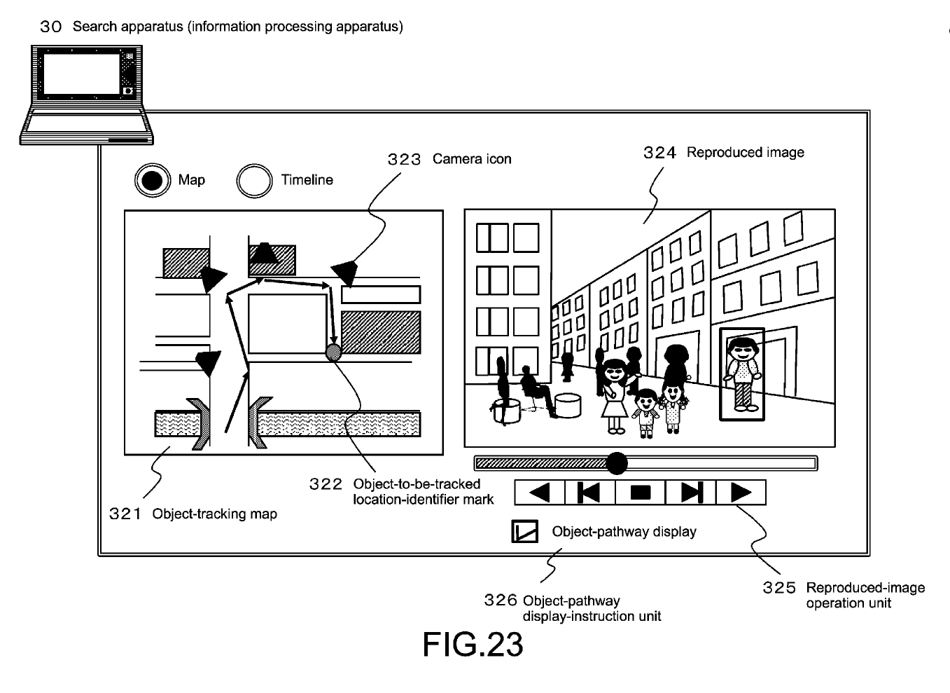

FIG. 23 is a diagram showing another example of displaying search result data, which is displayed on the basis of information selected from the candidate-object list 312 of FIG. 22.

FIG. 23 shows a search-result-display example, in which the route that a certain person, i.e., an object-to-be-searched-for, uses is displayed on a map.

As shown in FIG. 23, the object-tracking map 321 is displayed, and arrows showing the route of an object-to-be-searched-for-and-tracked are displayed on the map.

Further, the object-to-be-tracked location-identifier mark 322, which shows the current location of the object-to-be-searched-for-and-tracked, is displayed on the map.

The route on the map is generated on the basis of the location information on the objects, which are selected by the user from the candidate-object list 312 described with reference to FIG. 22.

The camera icons 323 are displayed on the object-tracking map 321 at the locations of the cameras that took the images of the objects selected by the user. The direction and the view angle of each camera are also displayed.

Note that, in addition to each camera icon, information on time, at which a search object passed by the location of the camera, and the thumbnail of the taken image may also be displayed (not shown). Where the user selects and specifies a thumbnail image of a taken image displayed in addition to a camera icon by using the cursor or the like, then the reproduced image 324 is displayed in an area next to the object-tracking map 321. The reproduced image 324 was taken before and after the time at which the image of the thumbnail image was taken.

By operating the reproduced-image operation unit 325, the reproduced image 324 can be reproduced normally, reproduced in reverse, fast-forwarded, and fast-rewound. By operating the slider, the reproducing position of the reproduced image 324 can be selected. Various kinds of processing can also be performed other than the above.

Further, where the object-to-be-searched-for is displayed in the reproduced image 324, a frame surrounding the object is displayed.

Further, where the object-pathway display-instruction unit 326 is checked, then a plurality of object frames indicating the pathway of the person-to-be-searched-for in the image can be displayed.

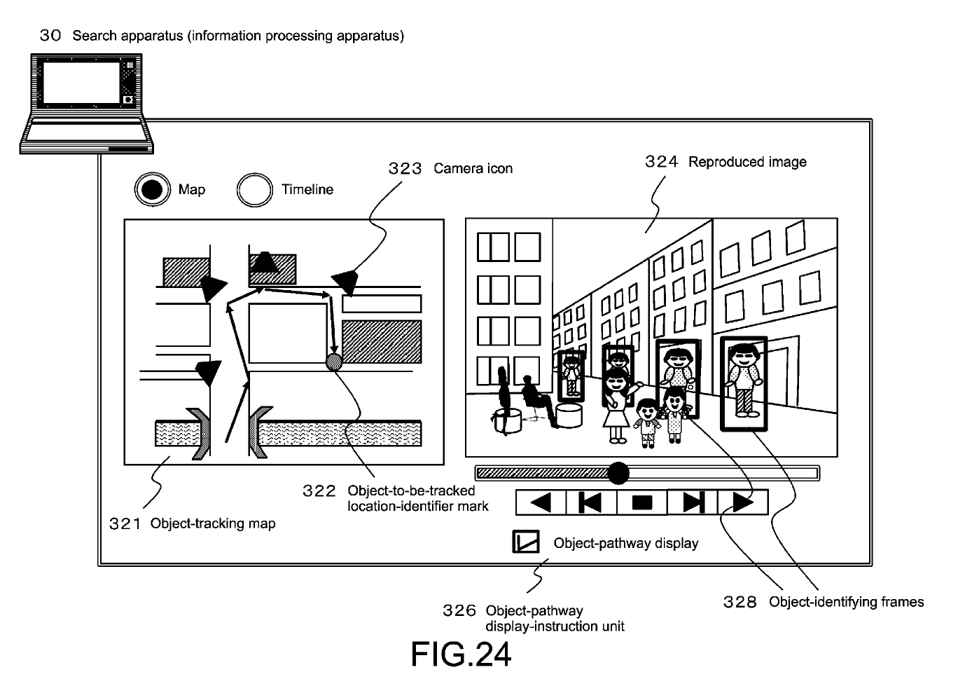

As shown in FIG. 24, for example, objects surrounded by the object-identifying frames 328 are displayed in the reproduced image 324 along the route that the object-to-be-searched-for uses.
Further, by selecting and clicking one of the object-identifying frames 328, a jump image, which includes the object at the position of the selected frame, can be reproduced.

Further, by selecting and right-clicking one of the object-identifying frames 328, a list for selecting one of data processing items is presented. By selecting one data processing item from the presented list by a user, one of various data processing items can be newly started.

Specifically, for example, the following data processing items can be newly started,
(A) searching for this object in addition, and
(B) searching for this object from the beginning

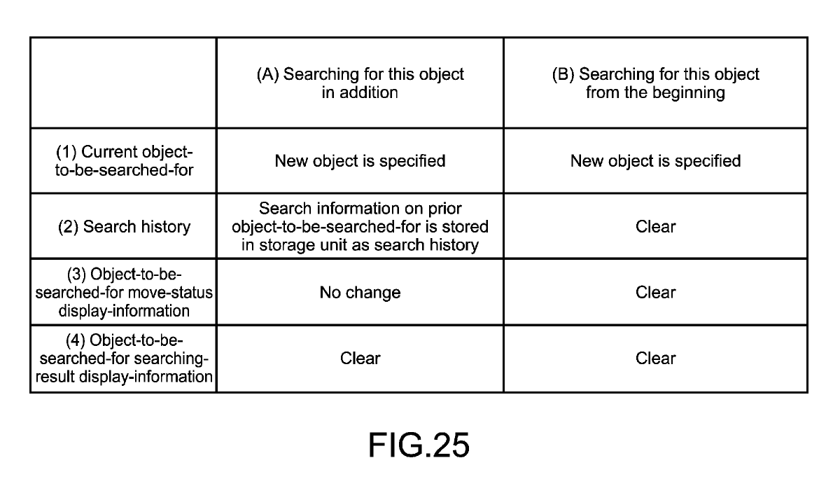

The processing will be described with reference to FIG. 25, where each of the new processing items is specified by a user and started.

In FIG. 25, one of the object-identifying frames 328 is selected, and one of the following processing items (A) and (B), i.e.,
(A) searching for this object in addition, and
(B) searching for this object from the beginning, is specified by a user. FIG. 25 is a diagram showing the processing modes of the following items (1) to (4) executed where one of the above-mentioned processing items (A) and (B) is specified by a user,
(1) current object-to-be-searched-for,
(2) search history,
(3) object-to-be-searched-for move-status display-information, and
(4) object-to-be-searched-for searching-result display-information.

For example, a user selects one of the object-identifying frames 328 of FIG. 24, and specifies the processing (A), i.e.,
(A) searching for this object in addition.

In this case,
(1) the current object-to-be-searched-for is changed to the object in the object-identifying frame selected by the user.
(2) The search history, i.e., the search information executed before selecting the object-identifying frame by the user, is stored in the storage unit.
(3) The object-to-be-searched-for move-status display-information is displayed as it is.
(4) The object-to-be-searched-for searching-result display-information is cleared.

Further, a user selects one of the object-identifying frames 328 of FIG. 24, and specifies the processing (B), i.e.,
(B) searching for this object from the beginning In this case,
(1) the current object-to-be-searched-for is changed to the object in the object-identifying frame selected by the user.
(2) The search history, i.e., the search information executed before selecting the object-identifying frame by the user, is not stored in the storage unit but cleared.
(3) The object-to-be-searched-for move-status display-information is cleared.
(4) The object-to-be-searched-for searching-result display-information is cleared.

Each of FIG. 23 and FIG. 24 shows an example in which the route of the object-to-be-searched-for is displayed on a map. Alternatively, a timeline may be displayed instead of a map.

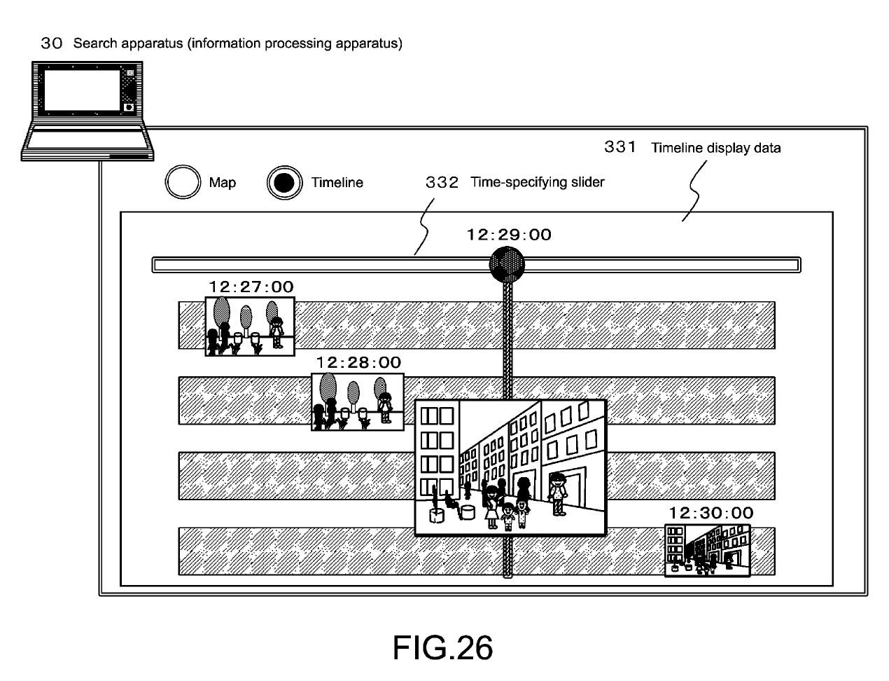

FIG. 26 shows an example in which a search result is displayed on a timeline.

In FIG. 26, the timeline display data 331 displays taken images of an object, which are selected by a user from the candidate-object list 312 described with reference to FIG. 22, along the time axis in series. The time-specifying slider 332 is operable by a user. By operating the time-specifying slider 332 by a user, the taken image of the object-to-be-searched-for at the specified time, which is enlarged, is displayed. In addition, the user can watch taken images of the object-to-be-searched-for before and after the specified time. The user can watch the images of object-to-be-searched-for taken in time series, and thereby confirm validness of movement of the object and the like.

### 7. Examples of Hardware Configuration of Each of Cameras and Other Apparatuses of Information Processing System

Next, examples of hardware configuration of each of the cameras 10 and the other apparatuses, i.e., the storage apparatus (server) 20 and the search apparatus (information processing apparatus) 30, of the information processing system of FIG. 1 will be described.

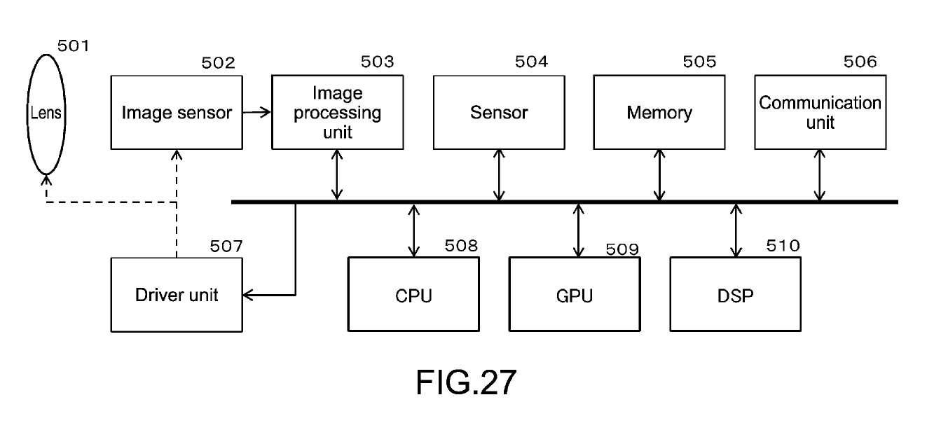

Firstly, an example of the hardware configuration of the camera 10 will be described with reference to FIG. 27.

FIG. 27 is a block diagram showing an example of the configuration of the camera (image processing apparatus) 10 of the present disclosure, which corresponds to the camera 10 of FIG. 1.

As shown in FIG. 27, the camera 10 includes the lens 501, the image sensor 502, the image processing unit 503, the sensor 504, the memory 505, the communication unit 506, the driver unit 507, the CPU 508, the GPU 509, and the DSP 510.

The image sensor 502 captures an image to be taken via the lens 501.

The image sensor 502 is, for example, a CCD (Charge Coupled Devices) image sensor, a CMOS (Complementary Metal Oxide Semiconductor) image sensor, or the like.

The image processing unit 503 receives input image data (RAW image) output from the image sensor 502, and reduces noises in the input RAW image. Further, the image processing unit 503 executes signal processing generally executed by a camera. For example, the image processing unit 503 demosaics the RAW image, adjusts the white balance (WB), executes gamma correction, and the like. In the demosaic processing, the image processing unit 503 sets pixel values corresponding to the full RGB colors to the pixel positions of the RAW image.

The sensor 504 is a sensor for taking an image under the optimum setting, e.g., a luminance sensor or the like. The image-taking mode for taking an image is controlled on the basis of information detected by the sensor 504.

The memory 505 is used to store taken images, and is used as areas storing processing programs executable by the camera 10, various kinds of parameters, and the like. The memory 505 includes a RAM, a ROM, and the like.

The communication unit 506 is a communication unit for communicating with the storage apparatus (server) 20 and the search apparatus (information processing apparatus) 30 of FIG. 1 via the network 40.

The driver unit 507 drives the lens and controls the diaphragm for taking images, and executes other various kinds of driver processing necessary to take images. The CPU 508 controls to execute the driver processing by using the information detected by the sensor 504, for example.

The CPU 508 controls various kinds of processing executable by the camera 10, e.g., taking images, analyzing images, generating metadata, communication processing, and the like. The CPU 508 executes the data processing programs stored in the memory 505 and thereby functions as a data processing unit that executes various kinds of processing.

The GPU (Graphics Processing Unit) 509 and the DSP (Digital Signal Processor) 510 are processors that process taken images, for example, and used to analyze the taken images. Similar to the CPU 508, each of the GPU 509 and the DSP 510 executes the data processing programs stored in the memory 505 and thereby functions as a data processing unit that processes images in various ways.

Note that the camera 10 of the present disclosure detects a movable target from a taken image, identifies an object, extracts a characteristic amount, and executes other kinds of processing.

The image processing unit 503, the CPU 508, the GPU 509, the DSP 510, and the like, each of which functions as a data processing unit, execute those kinds of data processing. The processing programs applied to those kinds of data processing are stored in the memory 505.

Note that, for example, the image processing unit 503 may include a dedicated hardware circuit, and the dedicated hardware may be configured to detect a movable target, identify an object, and extract a characteristic amount.
Further, processing executed by dedicated hardware and software processing realized by executing programs may be executed in combination as necessary to thereby execute the processing.

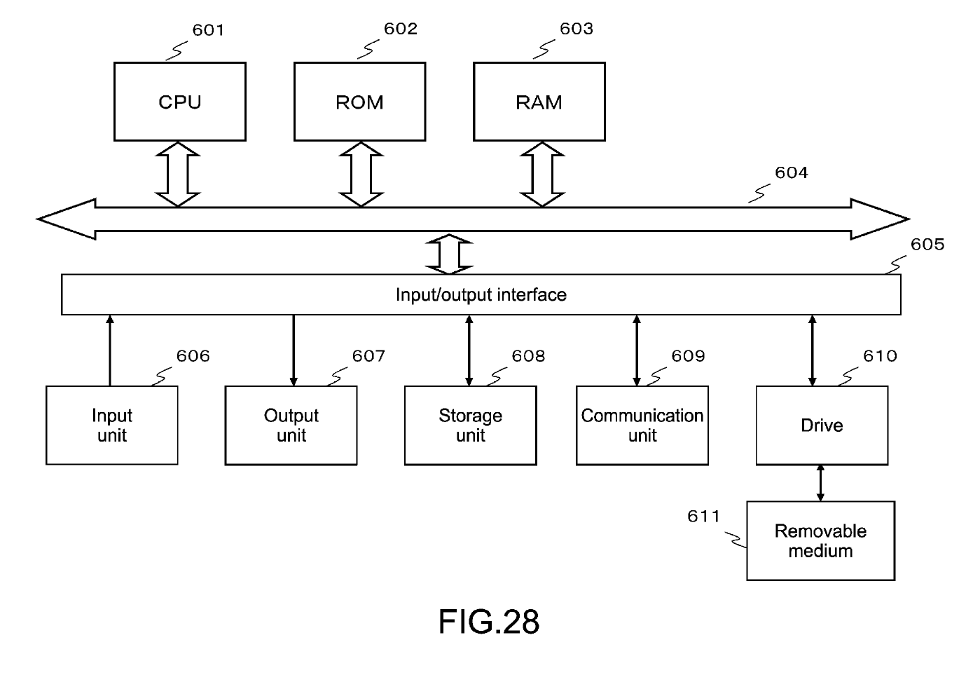

Next, an example of the hardware configuration of an information processing apparatus will be described with reference to FIG. 28. The information processing apparatus is applicable to the storage apparatus (server) 20 or the search apparatus (information processing apparatus) 30 of the system of FIG. 1.

The CPU (Central Processing Unit) 601 functions as a data processing unit, which executes programs stored in the ROM (Read Only Memory) 602 or the storage unit 608 to thereby execute various kinds of processing. For example, the CPU 601 executes the processing of the sequences described in the above-mentioned example. The programs executable by the CPU 601, data, and the like are stored in the RAM (Random Access Memory) 603. The CPU 601, the ROM 602, and the RAM 603 are connected to each other via the bus 604.

The CPU 601 is connected to the input/output interface 605 via the bus 604. The input unit 606 and the output unit 607 are connected to the input/output interface 605. The input unit 606 includes various kinds of switches, a keyboard, a mouse, a microphone, and the like. The output unit 607 includes a display, a speaker, and the like. The CPU 601 executes various kinds of processing in response to instructions input from the input unit 606, and outputs the processing result to the output unit 607, for example.

The storage unit 608 connected to the input/output interface 605 includes, for example, a hard disk or the like. The storage unit 608 stores the programs executable by the CPU 601 and various kinds of data. The communication unit 609 functions as a sending unit and a receiving unit for data communication via a network such as the Internet and a local area network, and communicates with external apparatuses.

The drive 610 connected to the input/output interface 605 drives the removable medium 611 such as a magnetic disk, an optical disc, a magneto-optical disk, and a semiconductor memory such as a memory card to record or read data.

### 8. Conclusion of Configuration of Present Disclosure

An example of the present disclosure has been described above with reference to a specific example. However, it is obvious that the example can be modified by people skilled in the art or the example can be substituted by another example without departing from the gist of the present disclosure. In other words, an example mode of the present technology has been disclosed, which should not be interpreted limitedly. The gist of the present disclosure should be determined with reference to the scope of claims.

Note that the technology disclosed in the present specification may employ the following configuration.

(1) An image processing apparatus, including:
a metadata generating unit configured to generate metadata corresponding to an object detected from an image,
the metadata generating unit including
   a movable-target-frame setting unit configured to set a movable-target frame for a movable-target object detected from an image,
   a movable-target-attribute determining unit configured to determine an attribute of
   a movable target, a movable-target frame being set for the movable target,
   a movable-target-frame-area dividing unit configured to divide a movable-target frame on the basis of a movable-target attribute,
   a characteristic-amount-extracting-divided-area deciding unit configured to decide a divided area from which a characteristic amount is to be extracted on the basis of a movable-target attribute,
   a characteristic-amount extracting unit configured to extract a characteristic amount from a divided area decided by the characteristic-amount-extracting-divided-area deciding unit, and
   a metadata recording unit configured to generate metadata, the metadata recording a characteristic amount extracted by the characteristic-amount extracting unit.

(2) The image processing apparatus according to (1), in which the movable-target-frame-area dividing unit is configured to
discern whether a movable-target attribute is a person or a vehicle, and
decide an area-dividing mode for a movable-target frame on the basis of a result-of-discerning.

(3) The image processing apparatus according to (1) or (2), in which the movable-target-frame-area dividing unit is configured to
where a movable-target attribute is a vehicle, discern a vehicle-type of a vehicle, and
decide an area-dividing mode for a movable-target frame depending a vehicle-type of a vehicle.

(4) The image processing apparatus according to any one of (1) to (3), in which the movable-target-frame-area dividing unit is configured to
where a movable-target attribute is a vehicle, discern an orientation of a vehicle, and decide an area-dividing mode for a movable-target frame on the basis of an orientation of a vehicle.

(5) The image processing apparatus according to any one of (1) to (4), in which the movable-target-frame-area dividing unit is configured to
obtain at least one of information on size of a movable-target frame and image-taking-angle information on a camera, and
decide an area-dividing mode of a movable-target frame on the basis of obtained information.

(6) The image processing apparatus according to any one of (1) to (5), in which the characteristic-amount-extracting-divided-area deciding unit is configured to
discern whether a movable-target attribute is a person or a vehicle, and
decide a divided area from which a characteristic amount is to be extracted on the basis of a result-of-discerning.

(7) The image processing apparatus according to any one of (1) to (6), in which the characteristic-amount-extracting-divided-area deciding unit is configured to
where a movable-target attribute is a vehicle, discern a vehicle-type of a vehicle, and
decide a divided area from which a characteristic amount is to be extracted depending a vehicle-type of a vehicle.

(8) The image processing apparatus according to any one of (1) to (7), in which the characteristic-amount-extracting-divided-area deciding unit is configured to
where a movable-target attribute is a vehicle, discern an orientation of a vehicle, and
decide a divided area from which a characteristic amount is to be extracted on the basis of an orientation of a vehicle.

(9) The image processing apparatus according to any one of (1) to (8), in which the characteristic-amount-extracting-divided-area deciding unit is configured to
obtain at least one of information on size of a movable-target frame and image-taking-angle information on a camera, and
decide a divided area from which a characteristic amount is to be extracted on the basis of obtained information.

(10) The image processing apparatus according to any one of (1) to (9), further including:
an image-taking unit, in which
the metadata generating unit is configured to
   input an image taken by the image-taking unit, and
   generate metadata corresponding to an object detected from a taken image.

(11) An information processing apparatus, including:
a data processing unit configured to search an image for an object, in which
the data processing unit is configured to search for an object on the basis of a characteristic amount of a characteristic-amount-extracting-area, the characteristic-amount-extracting-area being decided on the basis of an attribute of an object-to-be-searched-for.

(12) The information processing apparatus according to (11), in which
the data processing unit is configured to search for an object on the basis of a characteristic amount of a characteristic-amount-extracting-area, the characteristic-amount-extracting-area being decided on the basis of whether an attribute of an object-to-be-searched-for is a person or a vehicle.

(13) The information processing apparatus according to (11) or (12), in which
the data processing unit is configured to, where an attribute of an object-to-be-searched-for is a vehicle, search for an object on the basis of a characteristic amount of a characteristic-amount-extracting-area, the characteristic-amount-extracting-area being decided on the basis of a vehicle-type of a vehicle.

(14) The information processing apparatus according to any one of (11) to (13), in which
the data processing unit is configured to, where an attribute of an object-to-be-searched-for is a vehicle, search for an object on the basis of a characteristic amount of a characteristic-amount-extracting-area, the characteristic-amount-extracting-area being decided on the basis of an orientation of a vehicle.

(15) The information processing apparatus according to any one of (11) to (14), in which
the data processing unit is configured to search for an object on the basis of a characteristic amount of a characteristic-amount-extracting-area, the characteristic-amount-extracting-area being decided on the basis of at least one of information on size of a movable-target object in a searched image and image-taking-angle information on a camera.

(16) An image processing method executable by an image processing apparatus, the image processing apparatus including a metadata generating unit configured to generate metadata corresponding to an object detected from an image, the image processing method including:
executing by the metadata generating unit,
   a movable-target-frame setting step of setting a movable-target frame for a movable-target object detected from an image,
   a movable-target-attribute determining step of determining an attribute of a movable target, a movable-target frame being set for the movable target,
   a movable-target-frame-area dividing step of dividing a movable-target frame on the basis of a movable-target attribute,
   a characteristic-amount-extracting-divided-area deciding step of deciding a divided area from which a characteristic amount is to be extracted on the basis of a movable-target attribute,
   a characteristic-amount extracting step of extracting a characteristic amount from a divided area decided in the characteristic-amount-extracting-divided-area deciding step, and
   a metadata recording step of generating metadata, the metadata recording a characteristic amount extracted in the characteristic-amount extracting step.

(17) An information processing method executable by an information processing apparatus, the information processing apparatus including a data processing unit configured to search an image for an object, the information processing method including:
by the data processing unit,
searching for an object on the basis of a characteristic amount of a characteristic-amount-extracting-area, the characteristic-amount-extracting-area being decided on the basis of an attribute of an object-to-be-searched-for.

(18) A program causing an image processing apparatus to execute image processing, the image processing apparatus including a metadata generating unit configured to generate metadata corresponding to an object detected from an image, the program causing the metadata generating unit to execute:
a movable-target-frame setting step of setting a movable-target frame for a movable-target object detected from an image,
a movable-target-attribute determining step of determining an attribute of a movable target, a movable-target frame being set for the movable target,
a movable-target-frame-area dividing step of dividing a movable-target frame on the basis of a movable-target attribute,
a characteristic-amount-extracting-divided-area deciding step of deciding a divided area from which a characteristic amount is to be extracted on the basis of a movable-target attribute,
a characteristic-amount extracting step of extracting a characteristic amount from a divided area decided in the characteristic-amount-extracting-divided-area deciding step, and
a metadata recording step of generating metadata, the metadata recording a characteristic amount extracted in the characteristic-amount extracting step.

(19) A program causing an information processing apparatus to execute information processing, the information processing apparatus including a data processing unit configured to search an image for an object, the program causing the data processing unit to:
search for an object on the basis of a characteristic amount of a characteristic-amount-extracting-area, the characteristic-amount-extracting-area being decided on the basis of an attribute of an object-to-be-searched-for.

Further, the technology disclosed in the present specification may also employ the following configurations.
(1) An electronic system including: circuitry configured to
   detect an object from image data captured by a camera;
   divide a region of the image data corresponding to the object into a plurality of sub-areas based on attribute information of the object and an image capture characteristic of the camera;
   extract one or more characteristics corresponding to the object from one or more of the plurality of sub-areas; and
   generate characteristic data corresponding to the object based on the extracted one or more characteristics.
(2) The electronic system of (1), wherein the circuitry is configured to set a size of the region of the image based on a size of the object.
(3) The electronic system of any of (1) to (2), wherein the circuitry is configured to determine the attribute information of the object by comparing image data corresponding to the object to a library of known objects each associated with attribute information.
(4) The electronic system of any of (1) to (3), wherein in a case that the object is a person the attribute information indicates that the object is a person, and in a case that the object is a vehicle the attribute information indicates that the object is a vehicle.
(5) The electronic system of (4), wherein in a case that the object is a vehicle the attribute information indicates a type of the vehicle and an orientation of the vehicle.
(6) The electronic system of any of (1) to (5), wherein the image capture characteristic of the camera includes an image capture angle of the camera.
(7) The electronic system of any of (1) to (6), wherein the attribute information indicates a type of the detected object, and the circuitry is configured to determine a number of the plurality of sub-areas into which to divide the region based on the type of the object.
(8) The electronic system of any of (1) to (7), wherein the attribute information indicates an orientation of the detected object, and the circuitry is configured to determine a number of the plurality of sub-areas into which to divide the region based on the orientation of the object.
(9) The electronic system of any of (1) to (8), wherein the image capture characteristic of the camera includes an image capture angle of the camera, and the circuitry is configured to determine a number of the plurality of sub-areas into which to divide the region based on the image capture angle of the camera.
(10) The electronic system of any of (1) to (9), wherein the circuitry is configured to determine a number of the plurality of sub-areas into which to divide the region based on a size of the region of the image data corresponding to the object.
(11) The electronic system of any of (1) to (10), wherein the circuitry is configured to determine the one or more of the plurality of sub-areas from which to extract the one or more characteristics corresponding to the object. v(12) The electronic system of (11), wherein the attribute information indicates a type of the detected object, and the circuitry is configured to determine the one or more of the plurality of sub-areas from which to extract the one or more characteristics corresponding to the object based on the type of the object.
(13) The electronic system of any of (1) to (12), wherein the attribute information indicates an orientation of the detected object, and the circuitry is configured to determine the one or more of the plurality of sub-areas from which to extract the one or more characteristics corresponding to the object based on the orientation of the object.
(14) The electronic system of (1), wherein the image capture characteristic of the camera includes an image capture angle of the camera, and the circuitry is configured to determine the one or more of the plurality of sub-areas from which to extract the one or more characteristics corresponding to the object based on the image capture angle of the camera.
(15) The electronic system of any of (1) to (14), wherein the circuitry is configured to determine the one or more of the plurality of sub-areas from which to extract the one or more characteristics corresponding to the object based on a size of the region of the image data corresponding to the object.
(16) The electronic system of any of (1) to (15), wherein the circuitry is configured to generate, as the characteristic data, metadata corresponding to the object based on the extracted one or more characteristics.
(17) The electronic system of any of (1) to (16), further including: the camera configured to capture the image data; and a communication interface configured to transmit the image data and characteristic data corresponding to the object to a device via a network.
(18) The electronic system of any of (1) to (16), wherein the electronic system is a camera including the circuitry and a communication interface configured to transmit the image data and characteristic data to a server via a network.
(19) The electronic system of any of (1) to (18), wherein the extracted one or more characteristics corresponding to the object includes at least a color of the object.
(20) A method performed by an electronic system, the method including:
   detecting an object from image data captured by a camera;
   dividing a region of the image data corresponding to the object into a plurality of sub-areas based on attribute information of the object and an image capture characteristic of the camera;
   extracting one or more characteristics corresponding to the object from one or more of the plurality of sub-areas; and
   generating characteristic data corresponding to the object based on the extracted one or more characteristics.
(21) A non-transitory computer-readable medium including computer-program instructions, which when executed by an electronic system, cause the electronic system to:
   detect an object from image data captured by a camera; divide a region of the image data corresponding to the object into a plurality of sub-areas based on attribute information of the object and an image capture characteristic of the camera;
   extract one or more characteristics corresponding to the object from one or more of the plurality of sub-areas; and
   generate characteristic data corresponding to the object based on the extracted one or more characteristics.
(22) An electronic device including:
   a camera configured to capture image data; circuitry configured to
      detect a target object from the image data; set a frame on a target area of the image data based on the detected target object;
      determine an attribute of the target object in the frame;
      divide the frame into a plurality of sub-areas based on an attribute of the target
      object and an image capture parameter of the camera;
      determine one or more of the sub-areas from which a characteristic of the target object is to be extracted based on the attribute of the target object, the image capture parameter and a size of the frame;
      extract the characteristic from the one or more of the sub-areas; and generate metadata corresponding to the target object based on the extracted characteristic; and
      a communication interface configured to transmit the image data and the metadata to a device remote from the electronic device via a network.

Further, hardware, software, or configuration including both hardware and software in combination can execute a series of processing described in the present specification where software executes the processing, a program that records the processing sequence can be installed in a memory of a computer built in a dedicated hardware and the computer executes the processing sequence. Alternatively, the program can be installed in a general-purpose computer, which is capable of executing various kinds of processing, and the general-purpose computer executes the processing sequence. For example, the program can be previously recorded in a recording medium. The program recorded in the recording medium is installed in a computer. Alternatively, a computer can receive the program via a network such as a LAN (Local Area Network) and the Internet, and install the program in a built-in recording medium such as a hard disk.

Note that the various kinds of processing described in the present specification may be executed in time series as described above. Alternatively, the various kinds of processing may be executed in parallel or one by one as necessary or according to the processing capacity of the apparatus that executes the processing. Further, in the present specification, the system means logically-assembled configuration including a plurality of apparatuses. The configurational apparatuses may not necessarily be within a single casing.

It should be understood by those skilled in the art that various modifications, combinations, sub-combinations and alterations may occur on the basis of design requirements and other factors in so far as they are within the scope of the appended claims or the equivalents thereof.

### Industrial Applicability

As described above, according to the configuration of an example of the present disclosure, since a characteristic amount is extracted on the basis of an attribute of an object, it is possible to efficiently search for the object on the basis of the attribute of the object with a high degree of accuracy.

Specifically, a movable-target attribute of a movable-target object detected from an image is determined, a movable-target frame is divided on the basis of a movable-target attribute, and a divided area from which a characteristic amount is to be extracted is decided. A characteristic amount is extracted from the decided divided area, and metadata is generated. A mode of dividing the movable-target frame and a characteristic-amount-extracting-area are decided on the basis of whether a movable-target attribute is a person or a vehicle, and further on the basis of the vehicle-type, the orientation of the vehicle, the size of a movable-target frame, the depression angle of a camera, and the like. Metadata that records characteristic amount information is generated. An object is searched for by using the metadata, and thereby the object can be searched for in the optimum way on the basis of the object attribute.

According to the present configuration, a characteristic amount is extracted on the basis of an attribute of an object. Therefore it is possible to efficiently search for an object on the basis of an attribute of the object with a high degree of accuracy.

### Reference Signs List

10 camera (image processing apparatus)

20 storage apparatus (server)

30 search apparatus (information processing apparatus)

40 network

111 metadata generating unit

112 image processing unit

121 metadata storage unit

122 image storage unit

131 input unit

132 data processing unit

133 output unit

200 taken image

201 movable-target object detecting unit

202 movable-target-frame setting unit

203 movable-target-attribute determining unit

204 movable-target-frame-area dividing unit

205 characteristic-amount-extracting-divided-area deciding unit

206 divided-area characteristic-amount extracting unit

207 metadata recording-and-outputting unit

210 camera-installation-status parameter

220 metadata

501 lens

502 image sensor

503 image processing unit

504 sensor

505 memory

506 communication unit

507 driver unit

508 CPU

509 GPU

510 DSP

601 CPU

602 ROM

603 RAM

604 bus

605 input/output interface

606 input unit

607 output unit

608 storage unit

609 communication unit

610 drive

611 removal medium

1. An electronic system comprising:
circuitry configured to
detect an object from image data captured by a camera;
divide a region of the image data corresponding to the object into a plurality of sub-areas based on attribute information of the object and an image capture characteristic of the camera;
extract one or more characteristics corresponding to the object from one or more of the plurality of sub-areas; and
generate characteristic data corresponding to the object based on the extracted one or more characteristics.

2. The electronic system of claim 1, wherein
the circuitry is configured to set a size of the region of the image based on a size of the object.

3. The electronic system of claim 1, wherein
the circuitry is configured to determine the attribute information of the object by comparing image data corresponding to the object to a library of known objects each associated with attribute information.

4. The electronic system of claim 1, wherein
in a case that the object is a person the attribute information indicates that the object is a person, and
in a case that the object is a vehicle the attribute information indicates that the object is a vehicle.

5. The electronic system of claim 4, wherein
in a case that the object is a vehicle the attribute information indicates a type of the vehicle and an orientation of the vehicle.

6. The electronic system of claim 1, wherein
the image capture characteristic of the camera includes an image capture angle of the camera.

7. The electronic system of claim 1, wherein
the attribute information indicates a type of the detected object, and
the circuitry is configured to determine a number of the plurality of sub-areas into which to divide the region based on the type of the object.

8. The electronic system of claim 1, wherein
the attribute information indicates an orientation of the detected object, and
the circuitry is configured to determine a number of the plurality of sub-areas into which to divide the region based on the orientation of the object.

9. The electronic system of claim 1, wherein
the image capture characteristic of the camera includes an image capture angle of the camera, and
the circuitry is configured to determine a number of the plurality of sub-areas into which to divide the region based on the image capture angle of the camera.

10. The electronic system of claim 1, wherein
the circuitry is configured to determine a number of the plurality of sub-areas into which to divide the region based on a size of the region of the image data corresponding to the object.

11. The electronic system of claim 1, wherein
the circuitry is configured to determine the one or more of the plurality of sub-areas from which to extract the one or more characteristics corresponding to the object.

12. The electronic system of claim 11, wherein
the attribute information indicates a type of the detected object, and
the circuitry is configured to determine the one or more of the plurality of sub-areas from which to extract the one or more characteristics corresponding to the object based on the type of the object.

13. The electronic system of claim 1, wherein
the attribute information indicates an orientation of the detected object, and
the circuitry is configured to determine the one or more of the plurality of sub-areas from which to extract the one or more characteristics corresponding to the object based on the orientation of the object.

14. The electronic system of claim 1, wherein
the image capture characteristic of the camera includes an image capture angle of the camera, and
the circuitry is configured to determine the one or more of the plurality of sub-areas from which to extract the one or more characteristics corresponding to the object based on the image capture angle of the camera.

15. The electronic system of claim 1, wherein
the circuitry is configured to determine the one or more of the plurality of sub-areas from which to extract the one or more characteristics corresponding to the object based on a size of the region of the image data corresponding to the object.

16. The electronic system of claim 1, wherein
the circuitry is configured to generate, as the characteristic data, metadata corresponding to the object based on the extracted one or more characteristics.

17. The electronic system of claim 1, further comprising:
the camera configured to capture the image data; and
a communication interface configured to transmit the image data and characteristic data corresponding to the object to a device via a network.

18. The electronic system of claim 1, wherein
the electronic system is a camera including the circuitry and a communication interface configured to transmit the image data and characteristic data to a server via a network.

19. The electronic system of claim 1, wherein
the extracted one or more characteristics corresponding to the object includes at least a color of the object.

20. A method performed by an electronic system, the method comprising:
detecting an object from image data captured by a camera;
dividing a region of the image data corresponding to the object into a plurality of sub-areas based on attribute information of the object and an image capture characteristic of the camera;
extracting one or more characteristics corresponding to the object from one or more of the plurality of sub-areas; and
generating characteristic data corresponding to the object based on the extracted one or more characteristics.

21. A non-transitory computer-readable medium including computer-program instructions, which when executed by an electronic system, cause the electronic system to:
detect an object from image data captured by a camera;
divide a region of the image data corresponding to the object into a plurality of sub-areas based on attribute information of the object and an image capture characteristic of the camera;
extract one or more characteristics corresponding to the object from one or more of the plurality of sub-areas; and
generate characteristic data corresponding to the object based on
the extracted one or more characteristics.

22. An electronic device comprising:
a camera configured to capture image data;
circuitry configured to
detect a target object from the image data;
set a frame on a target area of the image data based on the detected target object;
determine an attribute of the target object in the frame;
divide the frame into a plurality of sub-areas based on an attribute of the target object and an image capture parameter of the camera;
determine one or more of the sub-areas from which a characteristic of the target object is to be extracted based on the attribute of the target object, the image capture parameter and a size of the frame;
extract the characteristic from the one or more of the subareas; and
generate metadata corresponding to the target object based on the extracted characteristic; and
a communication interface configured to transmit the image data and the metadata to a device remote from the electronic device via a network.
